(19) United States
(12) Patent Application Publication
(10) Pub. No.: US 2025/0007051 A1
(43) Pub. Date: Jan. 2, 2025

(54) SECONDARY BATTERY AND ELECTRONIC DEVICE

(71) Applicant: SEMICONDUCTOR ENERGY LABORATORY CO., LTD., Atsugi-shi, Kanagawa-ken (JP)

(72) Inventors: Kazutaka KURIKI, Ebina, Kanagawa (JP); Yumiko YONEDA, Isehara, Kanagawa (JP); Seiya SAITO, Atsugi, Kanagawa (JP); Tatsuyoshi TAKAHASHI, Atsugi, Kanagawa (JP)

(21) Appl. No.: 18/707,723

(22) PCT Filed: Oct. 31, 2022
(86) PCT No.: PCT/IB2022/060445

§ 371 Date: May 6, 2024

(30) Foreign Application Priority Data
Nov. 12, 2021 (JP) 2021-184543

(51) Int. Cl. H01M 50/129; H01M 50/54

(52) U.S. Cl. CPC H01M 50/129; H01M 50/54; H01M 2220/30

(57) ABSTRACT

A secondary battery that has flexibility and can inhibit degradation of a positive electrode lead connection portion or a negative electrode lead connection portion is provided. The secondary battery has a structure in which a positive electrode lead is connected to a positive electrode current collector exposed portion of a first positive electrode and a positive electrode current collector exposed portion of a second positive electrode while penetrating through the inner side of one opening portion of a first separator, an opening portion of a first negative electrode, and one opening portion of a second separator; a negative electrode lead is connected to a negative electrode current collector exposed portion of a first negative electrode while penetrating through the inner side of the other opening portion of the first separator; and the negative electrode lead and the negative electrode current collector exposed portion of the first negative electrode are connected to a negative electrode current collector exposed portion of a second negative electrode while penetrating through the inner side of the other opening portion of the second separator, an opening portion of the first positive electrode, an opening portion of the second positive electrode, and the other opening portion provided in a third separator.

### TECHNICAL FIELD

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification refers to all devices including power storage devices, and electro-optical devices including power storage devices, information terminal devices including power storage devices, and the like are all electronic devices.

Note that in this specification, a power storage device refers to all elements and devices each having a function of storing power. For example, a power storage device (also referred to as a secondary battery) such as a lithium-ion secondary battery, a lithium-ion capacitor, and an electric double layer capacitor are included.

### BACKGROUND ART

In recent years, wearable devices have been under active development. Since wearable devices are worn on one's body, they preferably have curved shapes along a curved surface of the body or they are preferably curved according to the movement of the body. Thus, not only displays and other housings but also secondary batteries mounted in wearable devices preferably have flexibility. Secondary batteries mounted in devices other than the wearable devices also preferably have flexibility because the space inside the devices can be used more efficiently when the secondary batteries can be changed in shapes.

As the secondary batteries, a variety of power storage devices such as lithium-ion secondary batteries, lithium-ion capacitors, and air batteries have been actively developed. In particular, demands for lithium-ion secondary batteries with high output and high energy density have rapidly grown with the industry development, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

For example, Patent Document 1 discloses as a flexible secondary battery an electrochemical device (e.g., a secondary battery or a capacitor) which is covered with a metal laminate and which can be easily curved or can easily maintain a curved state.

### REFERENCE

### Patent Document

[Patent Document 1] Japanese Published Patent Application No. 2004-241250
[Patent Document 2] Japanese Published Patent Application No. 2016-139608

### SUMMARY OF THE INVENTION

### Problems to be Solved by the Invention

A secondary battery with a curved shape includes an exterior body formed using a flexible material such as a laminated film, and is provided with a positive electrode lead and a negative electrode lead to take a positive electrode and a negative electrode out of the exterior body. Here, the positive electrode lead and the negative electrode lead are sandwiched by an exterior body and fixed. The positive electrode lead is connected to a positive electrode tab provided in the positive electrode, and the negative electrode lead is connected to a negative electrode tab provided in the negative electrode. The positive electrode tab and the negative electrode tab have elongated shapes in each electrode. Thus, the positive electrode tab and the negative electrode tab are likely to cause degradation such as a crack or a breakage compared with main portions of the electrodes.

In particular, in the case where the positive electrode lead and the negative electrode lead are each connected to a side of an end portion in a curved direction of the secondary battery as disclosed in Patent Document 1, stress due to transformation of the secondary battery tends to concentrate on a positive electrode lead connection portion and a negative electrode lead connection portion. Thus, the positive electrode lead connection portion and the negative electrode lead connection portion might be cracked or broken when a curved wearable device including the secondary battery is attached and detached repeatedly, for example.

In view of the above problems, for example, a structure in which the positive electrode lead and the negative electrode lead are not connected to the side of the end portion in the curved direction of the secondary battery has been studied as disclosed in Patent Document 2. However, there is room for improvement in the internal structure of the secondary battery, the method for manufacturing the secondary battery, and the like.

In view of the above problems, an object of one embodiment of the present invention is to provide a secondary battery with a structure that can inhibit degradation of a positive electrode or a negative electrode, in particular, a positive electrode lead connection portion or a negative electrode lead connection portion.

Another object of one embodiment of the present invention is to provide a method for manufacturing a secondary battery with a structure that can inhibit degradation of a positive electrode or a negative electrode, in particular, a positive electrode lead connection portion or a negative electrode lead connection portion.

Another object of one embodiment of the present invention is to provide a secondary battery with a novel structure. Specifically, an object is to provide a flexible secondary battery with a novel structure. Another object of one embodiment of the present invention is to provide a novel power storage device, an electronic device including a novel secondary battery, or the like.

Note that the description of these objects does not preclude the existence of other objects. In one embodiment of the present invention, there is no need to achieve all of these objects. Note that other objects will be apparent from the description of the specification, the drawings, the claims, and the like, and other objects can be derived from the description of the specification, the drawings, the claims, and the like.

### Means for Solving the Problems

To achieve the above objects, one embodiment of the present invention has a structure in which a secondary battery can be curved with reduced stress applied to a positive electrode lead connection portion or a negative electrode lead connection portion.

One embodiment of the present invention is a secondary battery including an external body surrounding a positive electrode, a negative electrode, and a separator, and a positive electrode lead and a negative electrode lead which extend from the inside to the outside of the external body. The positive electrode includes a positive electrode current collector exposed portion and a first opening portion. The negative electrode includes a negative electrode current collector exposed portion and a second opening portion. The separator includes a third opening portion and a fourth opening portion. The negative electrode lead is connected to the negative electrode current collector exposed portion at a position overlapping with the first opening portion and the third opening portion. The positive electrode lead is connected to the positive electrode current collector exposed portion at a position overlapping with the second opening portion and the fourth opening portion.

The above secondary battery preferably has flexibility, the secondary battery preferably includes a first region in the vicinity of the midpoint in the curved direction, and each of the first opening portion and the second opening portion preferably includes a region overlapping with the first region.

In the secondary battery described in any one of the above, the positive electrode lead and the negative electrode lead preferably extend from the inside to the outside of the exterior body in the first region.

In the secondary battery described in any one of the above, the exterior body preferably includes a depression and a projection.

In the secondary battery described in any one of the above, the negative electrode is preferably in contact with the exterior body with the separator therebetween.

One embodiment of the present invention is an electronic device including the secondary battery described in any one of the above.

Another embodiment of the present invention is an electronic device including a first housing, a second housing, a hinge portion, and a flexible battery. The first housing is connected to the second housing through the hinge portion. The flexible battery is placed so as to overlap with the first housing, the second housing, and the hinge portion. The flexible battery includes a positive electrode lead and a negative electrode lead in a region overlapping with the hinge portion.

Another embodiment of the present invention is an electronic device including a first housing, a second housing, a hinge portion, a flexible battery, and a flexible display. The first housing is connected to the second housing through the hinge portion. The flexible battery is placed so as to overlap with the first housing, the second housing, and the hinge portion. The flexible display is placed so as to overlap with the first housing, the second housing, and the hinge portion. The flexible battery includes a positive electrode lead and a negative electrode lead in a region overlapping with the hinge portion.

### Effect of the Invention

One embodiment of the present invention can provide a secondary battery with a structure that can inhibit degradation of a positive electrode or a negative electrode, in particular, a positive electrode lead connection portion or a negative electrode lead connection portion.

Another embodiment of the present invention can provide a method for manufacturing a secondary battery with a structure that can inhibit degradation of a positive electrode or a negative electrode, in particular, a positive electrode lead connection portion or a negative electrode lead connection portion.

Another embodiment of the present invention can provide a secondary battery with a novel structure. More specifically, a flexible secondary battery with a novel structure can be provided. Another embodiment of the present invention can provide a novel power storage device, an electronic device including a novel secondary battery, or the like.

Note that the description of these effects does not preclude the existence of other effects. One embodiment of the present invention does not necessarily have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A is a perspective view illustrating a structure example of a secondary battery and FIG. 1B is a top view illustrating a structure example of the secondary battery.

FIG. 2A to FIG. 2C are cross-sectional views illustrating a structure example of a secondary battery.

FIG. 3A and FIG. 3B are cross-sectional views illustrating a structure example of a secondary battery.

FIG. 4A and FIG. 4B are cross-sectional views illustrating the positions of an electrode when a secondary battery is curved.

FIG. 5A is a top view illustrating an example of a positive electrode, FIG. 5B is a top view illustrating an example of a negative electrode, and FIG. 5C is a top view illustrating an example of a separator.

FIG. 6A is a top view illustrating an example of a positive electrode, FIG. 6B is a top view illustrating an example of a negative electrode, and FIG. 6C is a top view illustrating an example of a separator.

FIG. 7A is a top view illustrating an example of a positive electrode, FIG. 7B is a top view illustrating an example of a negative electrode, and FIG. 7C is a top view illustrating an example of a separator.

FIG. 8 is a perspective view illustrating a structure example of a secondary battery.

FIG. 9A is a perspective view illustrating an example of a stacked body, and FIG. 9B is a top view illustrating an example of a bag-like separator.

FIG. TOA to FIG. 10C are perspective views illustrating a method for manufacturing a secondary battery.

FIG. 11A to FIG. 1C are diagrams illustrating a method for manufacturing a secondary battery.

FIG. 12A to FIG. 12C are perspective views illustrating a structure example of a secondary battery.

FIG. 13A is a perspective view illustrating an example of a stacked body, and FIG. 13B and FIG. 13C are perspective views each illustrating a structure example of a secondary battery.

FIG. 14A is a perspective view illustrating an example of a stacked body, and FIG. 14B and FIG. 14C are perspective views each illustrating a structure example of a secondary battery.

FIG. 15 is a diagram illustrating a method for processing a film.

FIG. 16A to FIG. 16E are diagrams each illustrating a method for processing a film.

FIG. 17A and FIG. 17B are diagrams illustrating a method for processing a film.

FIG. 18A to FIG. 18C are diagrams illustrating an electronic device of one embodiment of the present invention.

FIG. 19A and FIG. 19B are diagrams illustrating an electronic device of one embodiment of the present invention.

FIG. 20A to FIG. 20D are diagrams each illustrating an electronic device of one embodiment of the present invention.

FIG. 21A to FIG. 21D are diagrams each illustrating an electronic device of one embodiment of the present invention.

FIG. 22A to FIG. 22C are diagrams illustrating an electronic device of one embodiment of the present invention.

FIG. 23A to FIG. 23C are diagrams illustrating an electronic device of one embodiment of the present invention.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

The term “electrically connected” includes the case where components are connected through an “object having any electric function”. There is no particular limitation on the “object having any electric function” as long as electric signals can be transmitted and received between the components connected through the object.

The position, size, range, or the like of each component illustrated in drawings and the like is not accurately represented in some cases for easy understanding. Therefore, the disclosed invention is not necessarily limited to the position, size, range, and the like disclosed in the drawings and the like.

Ordinal numbers such as “first”, “second”, and “third” are used to avoid confusion among components.

In this specification, “parallel” indicates a state where two straight lines are placed at an angle greater than or equal to −10° and less than or equal to 10°. Thus, the case where the angle is greater than or equal to −5° and less than or equal to 5° is also included. In addition, “approximately parallel” or “substantially parallel” indicates a state where two straight lines are placed at an angle greater than or equal to −30° and less than or equal to 30°.

In this specification, “perpendicular” indicates a state where two straight lines are placed at an angle greater than or equal to 80° and less than or equal to 100°. Thus, the case where the angle is greater than or equal to 85° and less than or equal to 95° is also included. Furthermore, “approximately perpendicular” or “substantially perpendicular” indicates a state where two straight lines are placed at an angle greater than or equal to 60° and less than or equal to 120°.

The particle diameter of a particle can be measured by, for example, laser diffraction particle size distribution measurement and can be represented as D50. D50 is a particle diameter when the accumulated amount of particles accounts for 50% of an accumulated particle amount curve which is the result of the particle size distribution measurement, i.e., a median diameter. The measurement of the particle diameter of a particle is not limited to laser diffraction particle size distribution measurement; in the case where the particle diameter of a particle is less than or equal to the lower measurement limit of laser diffraction particle size distribution measurement, the cross-sectional diameter of the particle may be measured by analysis with a SEM (scanning electron microscope), a TEM (transmission electron microscope), or the like. As a method for measuring the particle diameter of a particle whose cross-sectional shape is not a circle, for example, the cross-sectional area of the particle is calculated by image processing or the like, whereby the particle diameter can be estimated assuming that the particle has a circular cross section with the equivalent area.

Note that in the drawings illustrating the present invention, some structures (e.g., the ratio between the size and the thickness of an electrode) are exaggerated for easy understanding in some cases. Furthermore, some components are not illustrated in some cases to avoid complexity of the drawings.

### Embodiment 1

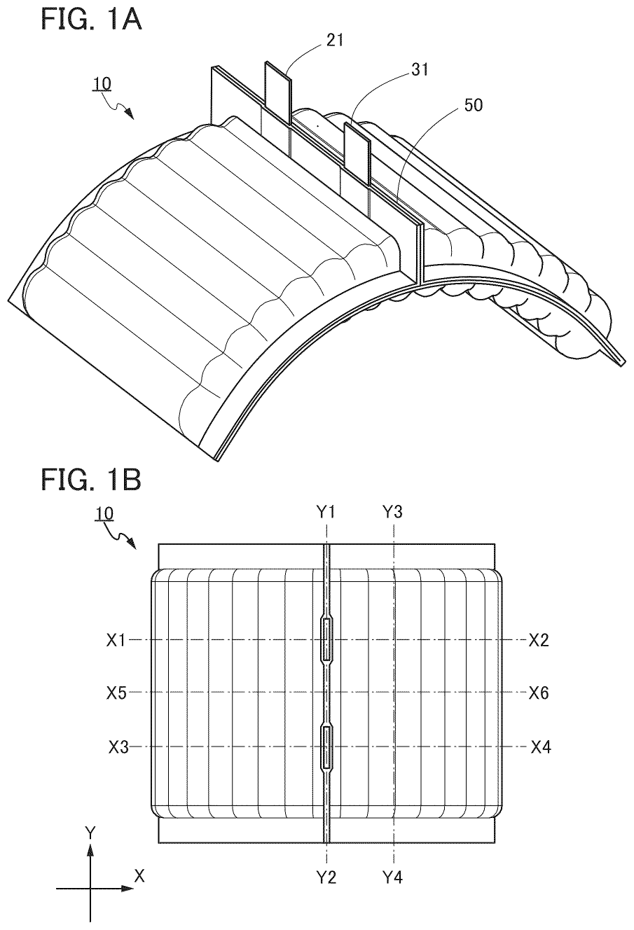

In this embodiment, structure examples of a flexible secondary battery (sometimes referred to as a flexible battery, a curved battery, or a bendable battery) of one embodiment of the present invention will be described with reference to FIG. 1 to FIG. 14.

### [Secondary Battery]

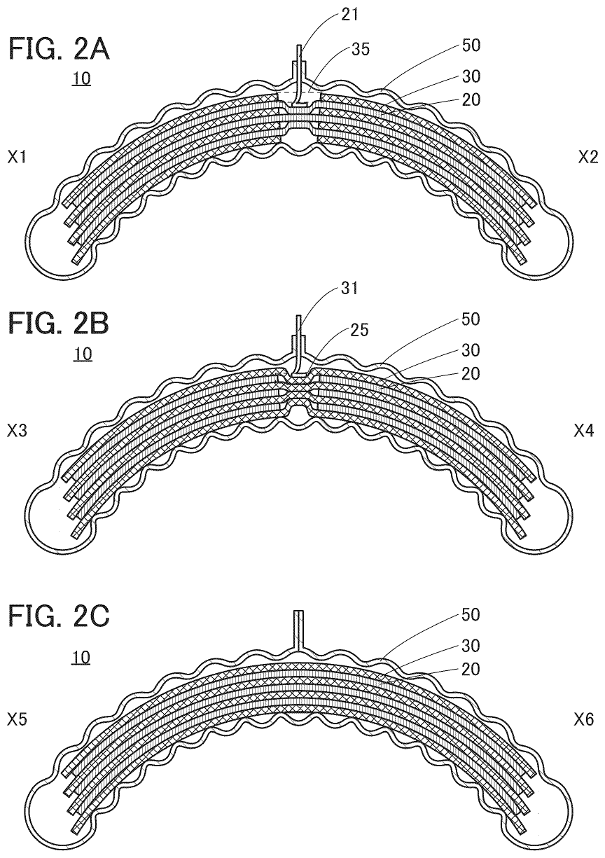

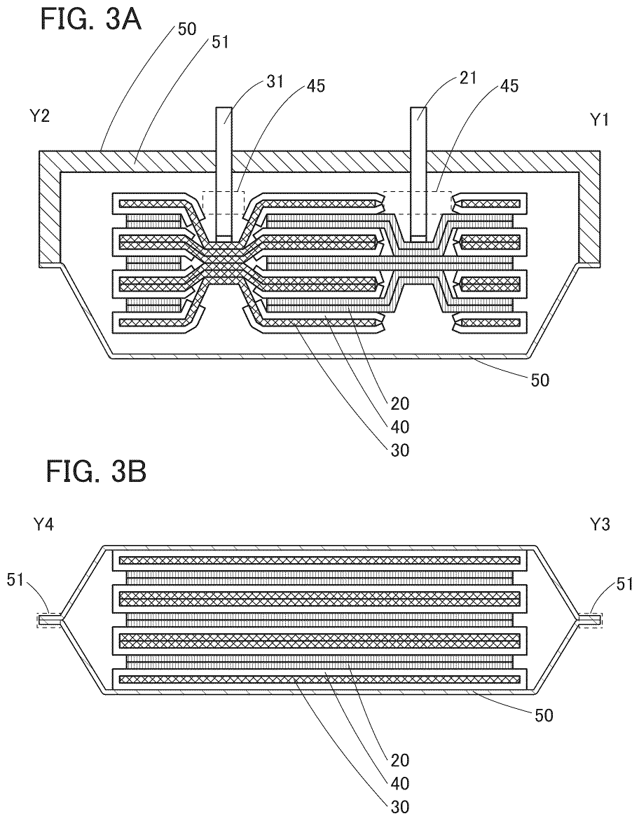

FIG. 1 to FIG. 3 illustrate schematic views of a secondary battery 10 of one embodiment of the present invention. FIG. TA is a perspective view of the secondary battery 10, FIG. 1B is a top view of the secondary battery 10, and FIG. 2A, FIG. 2B, FIG. 2C, FIG. 3A, and FIG. 3B are cross-sectional views of the secondary battery 10.

FIG. 1A and FIG. 1B are schematic views of the flexible secondary battery 10, which illustrate a state where the secondary battery 10 is curved in one direction. The secondary battery 10 includes an exterior body 50, and a positive electrode lead 21 and a negative electrode lead 31 which extend from the inside to the outside of a space surrounded by the exterior body 50.

As illustrated in FIG. TA and FIG. 1B, it is preferable that the positive electrode lead 21 and the negative electrode lead 31 not be provided on the side of the end portion in the curved direction of the secondary battery 10. In the case where the secondary battery 10 is curved with a single curvature, for example, the positive electrode lead 21 and the negative electrode lead 31 may be provided at the midpoint or in the vicinity of the midpoint in the curved direction of the secondary battery 10. When the positive electrode lead 21 and the negative electrode lead 31 are provided at such a position, the secondary battery 10 can be curved with reduced stress applied to the positive electrode lead 21 and the negative electrode lead 31. Note that the vicinity of the midpoint in the curved direction of the secondary battery 10 refers to the range of ±20% of the length of the secondary battery 10 in the curved direction from the position of the midpoint (e.g., a position from 3 to 7 with the length of the secondary battery in the curved direction being 10), preferably the range of ±10% (e.g., a position from 4 to 6 with the length of the secondary battery in the curved direction being 10).

FIG. 2A is a schematic cross-sectional view taken along dashed-dotted line X1-X2 in FIG. 1B, FIG. 2B is a schematic cross-sectional view taken along dashed-dotted line X3-X4 in FIG. 1B, and FIG. 2C is a schematic cross-sectional view taken along dashed-dotted line X5-X6 in FIG. 1B. Note that in FIG. 2A to FIG. 2C, a separator is not illustrated to avoid complexity of the drawings.

As illustrated in FIG. 2A, the secondary battery 10 includes a positive electrode 20, a negative electrode 30, and the positive electrode lead 21 in a space surrounded by the exterior body 50 (also referred to as the inside of the exterior body 50), and a plurality of positive electrodes 20 are connected to the positive electrode lead 21 in an opening portion 35 provided in the negative electrode 30.

As illustrated in FIG. 2B, the secondary battery 10 includes the positive electrode 20, the negative electrode 30, and the negative electrode lead 31 in the inside of the exterior body 50, and a plurality of negative electrodes 30 are connected to the negative electrode lead 31 in an opening portion 25 provided in the positive electrode 20.

As illustrated in FIG. 2B, the positive electrode 20 and the negative electrode 30 can have a structure in which no opening portion is included in a region other than the region where the positive electrode 20 is connected to the positive electrode lead 21 and the region where the negative electrode 30 is connected to the negative electrode lead 31.

Note that the positive electrode 20 and the positive electrode lead 21 may be connected to each other by welding a current collector of the positive electrode 20 to the positive electrode lead 21. Similarly, the negative electrode 30 and the negative electrode lead 31 may be connected to each other by welding a current collector of the negative electrode 30 to the negative electrode lead 31. Examples of the welding method include a ultrasonic welding method, a resistance welding method, and a laser welding method.

FIG. 3A is a schematic cross-sectional view taken along dashed-dotted line Y1-Y2 in FIG. 1B, and FIG. 3B is a schematic cross-sectional view taken along dashed-dotted line Y3-Y4 in FIG. 1B.

As illustrated in FIG. 3A, the secondary battery 10 includes the positive electrode 20, the negative electrode 30, a separator 40, the positive electrode lead 21, and the negative electrode lead 31 in a space surrounded by the exterior body 50 and a sealing portion 51 where the exterior body 50 is bonded (also referred to as the inside of the exterior body 50). The separator 40, which is not illustrated in FIG. 2A and FIG. 2B, also includes an opening portion 45; as in the description of the schematic cross-sectional views illustrated in FIG. 2A and FIG. 2B, a plurality of positive electrodes 20 are connected to the positive electrode lead 21 in the opening portion 45 provided in the separator 40 that overlaps with the opening portion 35 provided in the negative electrode 30. In addition, a plurality of negative electrodes 30 are connected to the negative electrode lead 31 in the opening portion 45 provided in the separator 40 that overlaps with the opening portion 25 provided in the positive electrode 20.

As illustrated in FIG. 3B, the positive electrode 20, the negative electrode 30, and the separator 40 can have a structure in which no opening portion is included in a region other than the region where the positive electrode 20 is connected to the positive electrode lead 21 and the region where the negative electrode 30 is connected to the negative electrode lead 31.

As illustrated in FIG. 2A to FIG. 3B, in the secondary battery 10 of one embodiment of the present invention, the positive electrode lead 21 is connected not at a protruding portion of an electrode current collector referred to as an electrode tab but inside the electrode (an exposed portion of the current collector (an opening portion of an active material layer)). The negative electrode lead 31 is also connected inside the electrode. Here, these connection portions are referred to as a positive electrode lead connection portion and a negative electrode lead connection portion. When the positive electrode lead connection portion and the negative electrode lead connection portion are provided inside the electrode as described above, the secondary battery 10 can be curved while the stress applied to the positive electrode lead connection portion and the negative electrode lead connection portion is easily dispersed.

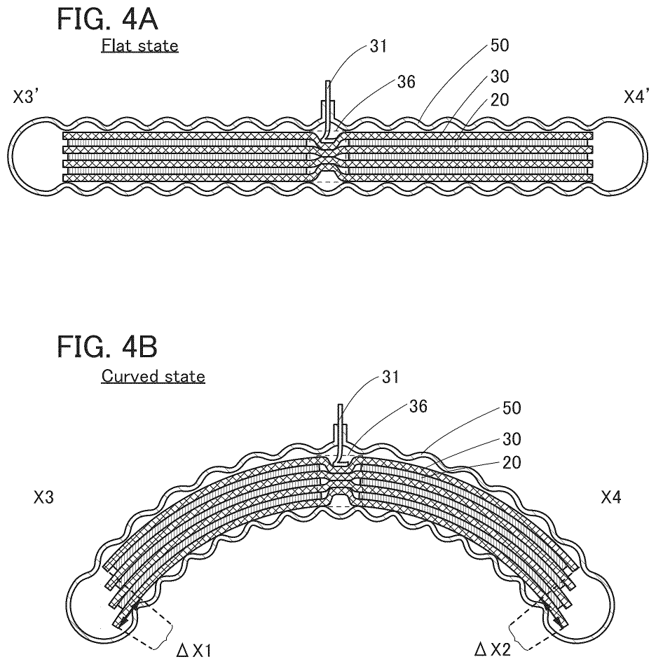

The positions of the positive electrode lead connection portion and the negative electrode lead connection portion are important to reduce the stress applied to the positive electrode lead connection portion and the negative electrode lead connection portion when the secondary battery 10 is curved. Preferable positions of the positive electrode lead connection portion and the negative electrode lead connection portion are described with reference to FIG. 4A and FIG. 4B.

FIG. 4A and FIG. 4B are schematic cross-sectional views taken along dashed-dotted line X3-X4 in FIG. 1B. FIG. 4A illustrates a state where the secondary battery 10 is not curved (a flat state) and FIG. 4B illustrates a state where the secondary battery 10 is curved (a curved state). As in FIG. 2A to FIG. 2C, the separator is not illustrated in FIG. 4A and FIG. 4B.

When the secondary battery 10 is curved, the shift of the positive electrode 20 and the negative electrode 30 is preferably small in the positive electrode lead connection portion and the negative electrode lead connection portion. At this time, the positions of end portions of a plurality of positive electrodes 20 and a plurality of negative electrodes 30 are shifted on the side of the end portion in the curved direction of the secondary battery 10. However, stress generated in the electrodes (the positive electrodes 20 and the negative electrodes 30) in curving is small because the plurality of positive electrodes 20 are not connected to each other and the plurality of negative electrodes 30 are not connected to each other on the side of the end portion in the curved direction of the secondary battery 10 (also referred to as an open end).

For example, in the case where the secondary battery 10 is curved with a single curvature, the positive electrode lead connection portion and the negative electrode lead connection portion are preferably provided at the midpoint or in the vicinity of the midpoint in the curved direction of the secondary battery 10. In that case, a shift amount ΔX1 in one end portion of the electrode and a shift amount ΔX2 in the other end portion of the electrode illustrated in FIG. 4B are equal to each other, so that the stress applied to the electrodes (the positive electrodes 20 and the negative electrodes 30) is dispersed uniformly. That is, it is possible to inhibit the electrodes (the positive electrodes 20 and the negative electrodes 30), specifically the positive electrode lead connection portion or the negative electrode lead connection portion from being degraded by curving of the secondary battery 10.

Note that as illustrated in FIG. 4B, the shift amount ΔX1 in one end portion of the electrode refers to the distance between an end portion of the innermost electrode of the curve (referred to as an end portion of a first electrode) and an end portion of the outermost electrode of the curve (referred to as an end portion of a second electrode) among the end portions in the curved direction of the secondary battery 10. Specifically, when the end portion of the first electrode is referred to as a first point and the intersection between the first electrode and the shortest straight line from the end portion of the second electrode to the first electrode is referred to as a second point, the distance between the first point and the second point is ΔX1.

The secondary battery 10 of one embodiment of the present invention includes two end portions in the curved direction; thus, in an end portion other than the above, an end portion of the innermost electrode of the curve can be referred to as an end portion of a third electrode and an end portion of the outermost electrode of the curve can be referred to as an end portion of a fourth electrode. Here, when the end portion of the third electrode is referred to as a third point and the intersection between the third electrode and the shortest straight line from the end portion of the fourth electrode to the third electrode is referred to as a fourth point, the distance between the third point and the fourth point is ΔX2.

In the secondary battery 10 of one embodiment of the present invention, the position where the positive electrode lead 21 is connected to the positive electrode 20 and the position where the negative electrode lead 31 is connected to the negative electrode 30 are preferably determined such that the ratio of the shift amount ΔX2 to the shift amount ΔX1 (ΔX2/ΔX1) in curving the secondary battery 10 is greater than or equal to 0.5 and less than or equal to 2, further preferably greater than or equal to 0.7 and less than or equal to 1.43, still further preferably greater than or equal to 0.8 and less than or equal to 1.25, and yet further preferably greater than or equal to 0.9 and less than or equal to 1.11. In that case, the stress applied to the electrodes (the positive electrodes 20 and the negative electrodes 30) is dispersed uniformly. That is, it is possible to inhibit electrodes (the positive electrodes 20 and the negative electrodes 30), specifically the positive electrode lead connection portion or the negative electrode lead connection portion from being degraded by curving of the secondary battery 10.

Note that FIG. 1 to FIG. 4 illustrate an example in which the positive electrode lead 21 and the negative electrode lead 31 are provided on the outer side of the curved direction of the secondary battery 10; alternatively, the secondary battery 10 may be curved so that the positive electrode lead 21 and the negative electrode lead 31 are provided on the inner side of the curved direction of the secondary battery 10. The secondary battery 10 may be curved not only in one direction but in two directions so as to draw an S shape in a side view of the secondary battery 10, and also in three or more directions.

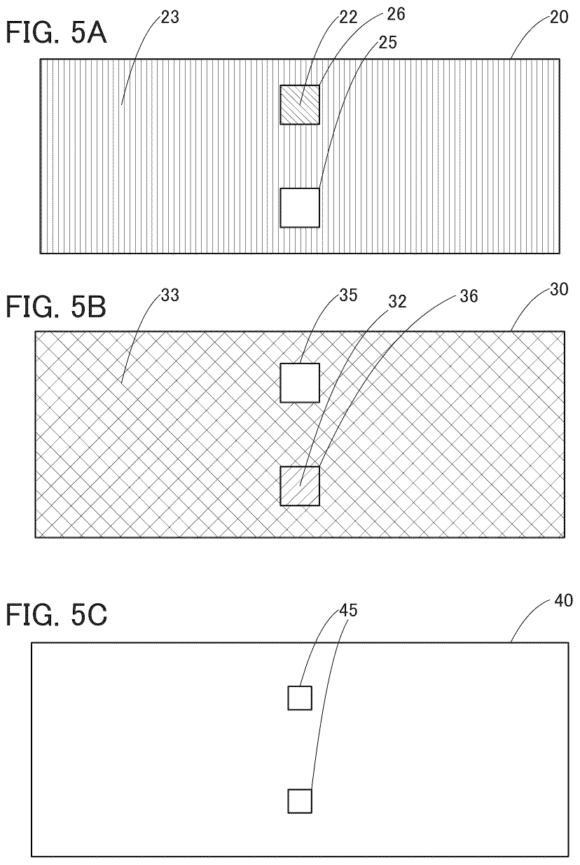

Details of the structure of the secondary battery 10 of one embodiment of the present invention and an example of a manufacturing method thereof are described with reference to FIG. 5 to FIG. 11.

### [Shapes of Positive Electrode, Negative Electrode, and Separator]

FIG. 5A is a schematic top view of the positive electrode 20 included in the secondary battery 10 of one embodiment of the present invention, FIG. 5B is a schematic top view of the negative electrode 30 included in the secondary battery 10 of one embodiment of the present invention, and FIG. 5C is a schematic top view of the separator 40 included in the secondary battery 10 of one embodiment of the present invention.

The positive electrode 20 includes a positive electrode current collector 22 and a positive electrode active material layer 23 over the positive electrode current collector 22. As illustrated in FIG. 5A, the positive electrode current collector 22 and the positive electrode active material layer 23 include the opening portion 25 provided in the positive electrode 20. The positive electrode 20 also includes a positive electrode current collector exposed portion 26, which is over the positive electrode current collector 22 and does not include the positive electrode active material layer 23.

The negative electrode 30 includes a negative electrode current collector 32 and a negative electrode active material layer 33 over the negative electrode current collector 32. As illustrated in FIG. 5B, the negative electrode current collector 32 and the negative electrode active material layer 33 include the opening portion 35 provided in the negative electrode. The negative electrode 30 also includes a negative electrode current collector exposed portion 36, which is over the negative electrode current collector 32 and does not include the negative electrode active material layer 33.

The separator 40 includes a plurality of opening portions 45 as illustrated in FIG. 5C.

Examples of a method for forming the opening portion 25 provided in the positive electrode 20 illustrated in FIG. 5A include a punching processing method and a laser processing method. The positive electrode current collector exposed portion 26 of the positive electrode 20 illustrated in FIG. 5A can be formed by, for example, removing the positive electrode active material layer 23 by a laser processing method or the like.

Examples of a method for forming the opening portion 35 provided in the negative electrode 30 illustrated in FIG. 5B include a punching processing method and a laser processing method. The negative electrode current collector exposed portion 36 of the negative electrode 30 illustrated in FIG. 5B can be formed by, for example, removing the negative electrode active material layer 33 by a laser processing method or the like.

Examples of a method for forming the opening portion 45 provided in the separator 40 illustrated in FIG. 5C include a punching processing method and a laser processing method. The opening portion 45 is preferably smaller than the opening portion 25 and the opening portion 35.

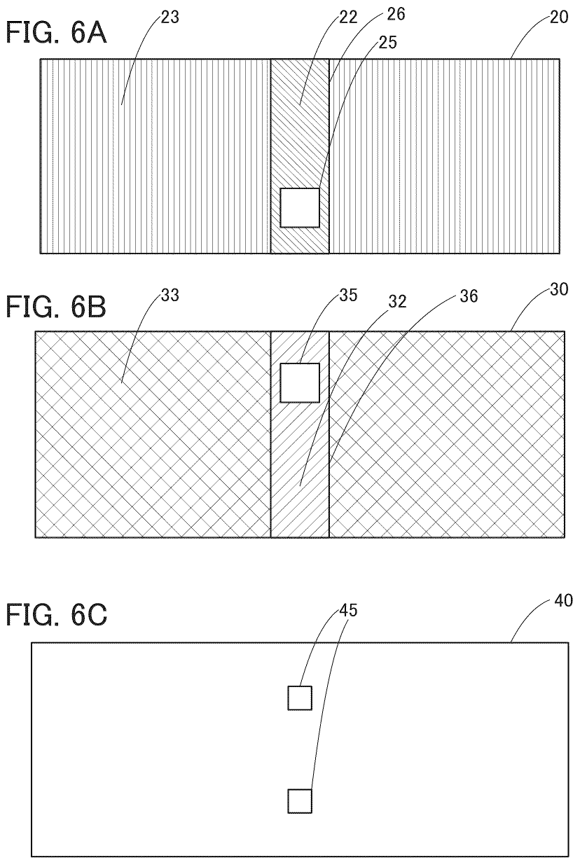

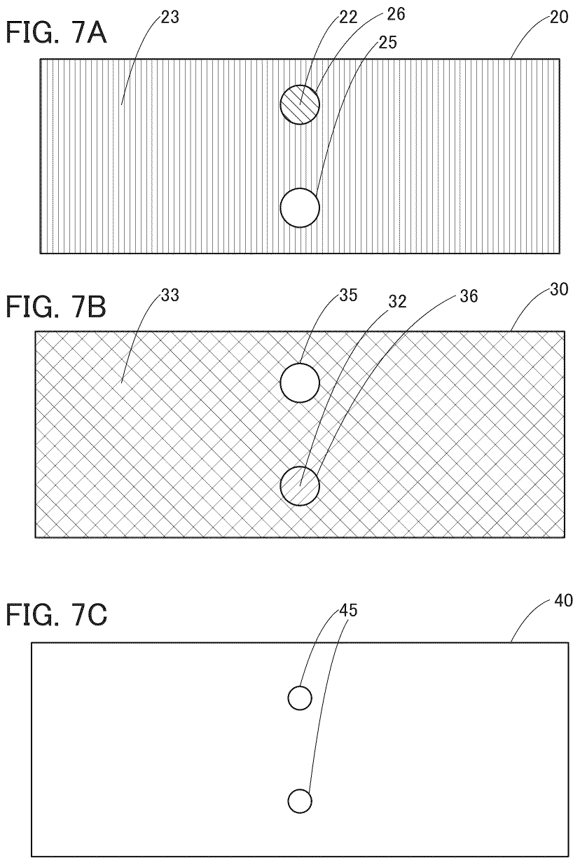

Note that the shapes of the opening portion 25, the opening portion 35, the opening portion 45, the positive electrode current collector exposed portion 26, and the negative electrode current collector exposed portion 36 included in the positive electrode 20, the negative electrode 30, and the separator 40 are not limited to those illustrated in FIG. 5A to FIG. 5C. For example, as illustrated in FIG. 6A to FIG. 6C, the positive electrode current collector exposed portion 26 and the negative electrode current collector exposed portion 36 may have band-like shapes instead of opening shapes. As illustrated in FIG. 7A to FIG. 7C, the opening and the current collector exposed portion may have circular shapes instead of rectangular shapes. The opening and the current collector exposed portion may have polygonal shapes other than rectangular and circular shapes or may have elliptical shapes. The opening portion 25, the opening portion 35, the opening portion 45, the positive electrode current collector exposed portion 26, and the negative electrode current collector exposed portion 36 illustrated in FIG. 6A to FIG. 7C can be formed by a method similar to that illustrated in FIG. 5A to FIG. 5C. Note that the positive electrode current collector exposed portion 26 illustrated in FIG. 6A can also be formed when the positive electrode active material layer 23 of the positive electrode 20 is formed by an intermittent coating method. The negative electrode current collector exposed portion 36 illustrated in FIG. 6B can also be formed when the negative electrode active material layer 33 of the negative electrode 30 is formed by an intermittent coating method.

### [Stacked Body]

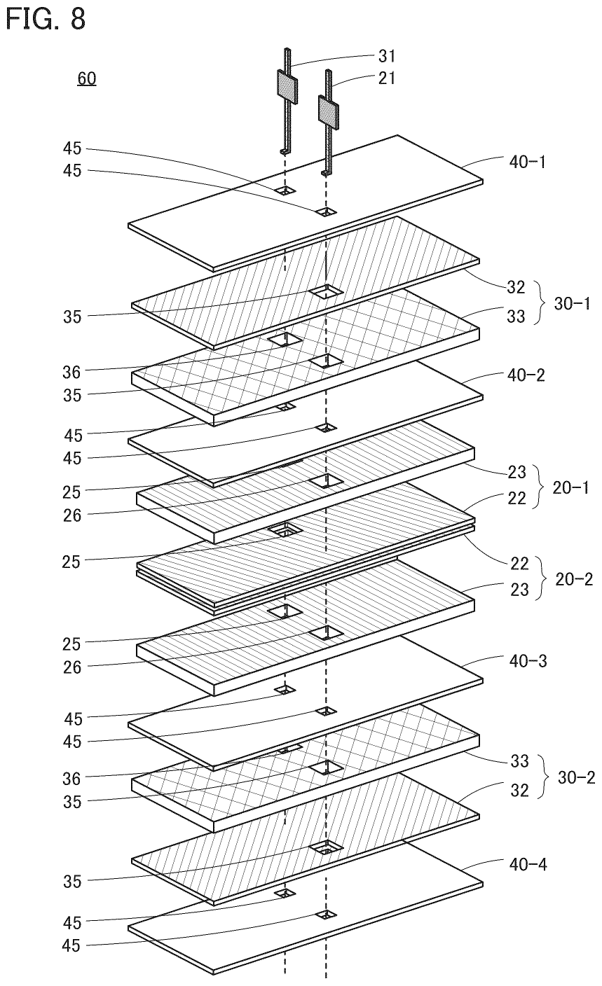

FIG. 8 is a diagram illustrating a stacked body 60 including the positive electrode 20, the negative electrode 30, the separator 40, the positive electrode lead 21, and the negative electrode lead 31. Note that in FIG. 8, the negative electrode current collector and the negative electrode active material layer are separated from each other, and the positive electrode current collector and the positive electrode active material layer are separated from each other for easy understanding of the positional relation between the opening portion and the current collector exposed portion; in actual manufacturing, the negative electrode current collector and the negative electrode active material layer are integrated as the negative electrode 30, and the positive electrode current collector and the positive electrode active material layer are integrated as the positive electrode 20.

As illustrated in FIG. 8, the positive electrode lead 21 is connected to the positive electrode current collector exposed portion 26 of a first positive electrode 20-1 and the positive electrode current collector exposed portion 26 of a second positive electrode 20-2 while penetrating through the inner side of one of the opening portions 45 of a first separator 40-1, the opening portion 35 of a first negative electrode 30-1, and one of the opening portions 45 of a second separator 40-2. Here, the connection portions are referred to as positive electrode lead connection portions. Note that in a top view of the stacked body 60, one of the opening portions 45 of a third separator 40-3, the opening portion 35 of a second negative electrode 30-2, and one of the opening portions 45 of a fourth separator 40-4 are positioned so as to overlap with the positive electrode lead connection portions.

The negative electrode lead 31 is connected to the negative electrode current collector exposed portion 36 of the first negative electrode 30-1 while penetrating through the inner side of the other of the opening portions 45 of the first separator 40-1. The negative electrode lead 31 and the negative electrode current collector exposed portion 36 of the first negative electrode 30-1 are connected to the negative electrode current collector exposed portion 36 of the second negative electrode 30-2 while penetrating through the inner side of the other of the opening portions 45 of the second separator 40-2, the opening portion 25 of the first positive electrode 20-1, the opening portion 25 of the second positive electrode 20-2, and the other of the opening portions 45 provided in a third separator 40. Here, the connection portions are referred to as negative electrode lead connection portions. Note that in a top view of the stacked body 60, the other of the opening portions 45 of the fourth separator 40-4 is positioned so as to overlap with the negative electrode lead connection portions.

As described above with reference to FIG. 1A and FIG. 1B, the connection positions of the positive electrode lead 21 and the negative electrode lead 31 may be at the midpoint or in the vicinity of the midpoint in the curved direction of the secondary battery 10. The connection positions may be at the midpoint or in the vicinity of the midpoint in the curved direction of the positive electrode 20 in the secondary battery 10, or at the midpoint or in the vicinity of the midpoint in the curved direction of the negative electrode 30 in the secondary battery 10. That is, the opening portion 25 provided in the positive electrode 20, the opening portion 35 provided in the negative electrode 30, and the opening portion 45 provided in the separator 40 may be provided so as to overlap with the midpoint or the vicinity of the midpoint in the curved direction of the secondary battery 10.

The stacked body 60 can be manufactured in the aforementioned manner. Note that the connection of the positive electrode lead 21 and the connection of the negative electrode lead 31 are preferably performed by welding; for example, a ultrasonic welding method, a resistance welding method, or a laser welding method can be used as a welding method.

The stacked body 60 illustrated in FIG. 8 includes two positive electrodes 20, two negative electrodes 30, four separators 40, the positive electrode lead 21, and the negative electrode lead 31; however, the numbers of the positive electrodes 20, the negative electrodes 30, and the separators 40 are not limited thereto. The stacked body 60 may include one positive electrode 20, one negative electrode 30, and one separator 40, or may include three or more positive electrodes 20, three or more negative electrodes 30, and three or more separators 40.

Note that when one separator 40 is provided for a pair of the positive electrode 20 and the negative electrode 30 (more specifically, a pair of the positive electrode active material layer 23 and the negative electrode active material layer 33), a short circuit between the positive electrode 20 and the negative electrode 30 can be prevented and the secondary battery can operate. In that case, the positive electrode current collector 22 or the negative electrode current collector 32 includes a region in contact with the exterior body 50.

Each of the top surface and the bottom surface of the stacked body 60 is preferably provided with one separator 40. The stacked body 60 with such a structure can inhibit the positive electrode current collector 22 and/or the negative electrode current collector 32 included in the stacked body 60 from rubbing against the inner surface of the exterior body 50 and cutting off the exterior body 50 when the secondary battery 10 is curved, so that degradation of the exterior body 50 due to curving of the secondary battery 10 can be inhibited. That is, the number of the separators 40 is preferably two plus the number of pairs of the positive electrodes 20 and the negative electrodes 30. In other words, the positive electrode current collector 22 and the exterior body 50 are preferably in contact with each other with the separator 40 therebetween. The negative electrode current collector 32 and the exterior body 50 are preferably in contact with each other with the separator 40 therebetween.

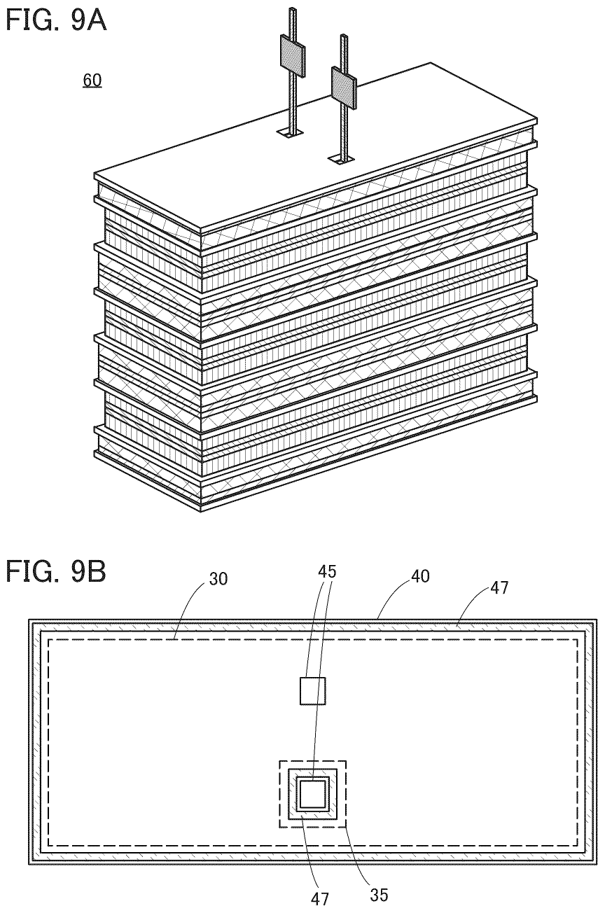

For example, FIG. 9A illustrates an example in which the stacked body 60 includes the positive electrode lead 21, the negative electrode lead 31, six positive electrodes 20, six negative electrodes 30, and eight separators 40. Although FIG. 9A and the like illustrate a plurality of separators 40 that are stacked independently from one another, two separators 40 may be bonded to each other to have a bag-like shape and surround the electrode (e.g., the negative electrode 30) as illustrated in FIG. 9B. A bonding portion 47 where the two separators 40 are bonded to each other may be provided not only on the outer edge of the separator 40 but also in the periphery of the opening portion 45 provided in the separator 40 as illustrated in FIG. 9B. Although FIG. 9B illustrates an example in which the two separators 40 are bonded to each other, one separator may be folded in two, and the other three sides of the outer edge of the separator may be bonded to surround the electrode as in FIG. 9B. The same applies to the separator 40 illustrated in FIG. 3A, FIG. 3B, FIG. 8, and FIG. 9A; two separators 40 in the drawings may be one separator 40 folded in two, and three or more separators 40 in the drawings may be one separator 40 folded in three or more (or in zigzag).

FIG. 8 and FIG. 9A illustrate an example in which the positive electrode 20 and the negative electrode 30 are single-side-coated electrodes. That is, FIG. 8 and FIG. 9A illustrate an example in which the positive electrode 20 is a single-side-coated electrode including the positive electrode active material layer 23 on one surface of the positive electrode current collector 22 and not including the positive electrode active material layer 23 on the other surface of the positive electrode current collector 22. In the example illustrated in FIG. 8 and FIG. 9A, the negative electrode 30 is a single-side-coated electrode including the negative electrode active material layer 33 on one surface of the negative electrode current collector 32 and not including the negative electrode active material layer on the other surface of the negative electrode current collector 32. The positive electrode 20 and the negative electrode 30 included in the secondary battery 10 of one embodiment of the present invention are not limited to the above examples, and may be double-side-coated electrodes each including an active material layer on both surfaces of a current collector.

Note that in the case where the stacked body 60 is manufactured using single-side-coated positive electrodes and single-side-coated negative electrodes as illustrated in FIG. 8 and FIG. 9A, two single-side-coated positive electrodes are preferably stacked so that surfaces not provided with positive electrode active material layers (current collector surfaces) are in contact with each other (such a structure is sometimes referred to as a back-to-back structure). The same applies to the case where two single-side-coated negative electrodes are stacked; surfaces not provided with negative electrode active material layers (current collector surfaces) are preferably in contact with each other. In the stacked body 60 with such a structure, stress applied to the positive electrode 20 and the negative electrode 30 when the secondary battery 10 is curved can be reduced because the contact surface of the current collector surfaces serves as a slip plane of the stacked body 60. That is, the secondary battery 10 can be easily curved.

FIG. 10 to FIG. 14 are diagrams illustrating the exterior body 50 that surrounds the stacked body 60. Note that the stacked body 60 and the exterior body 50 are simplified to avoid complexity of the drawings.

FIG. 10A is a simplified schematic view of the stacked body 60 illustrated in FIG. 9A and the like. As illustrated in FIG. 10B, the exterior body 50 is prepared at the position where the stacked body 60 is surrounded. Next, as illustrated in FIG. 10C, the exterior body 50 is bonded to form the sealing portion 51. At this time, the sealing portion 51 may be formed so that the positive electrode lead 21 and the negative electrode lead 31 included in the stacked body 60 are sandwiched by the exterior body 50 as illustrated in the drawing. The exterior body 50 may be bonded by a method in which a resin layer on one surface of the exterior body 50 is fused using a heat bar sealing apparatus. Alternatively, an adhesive may be used for bonding.

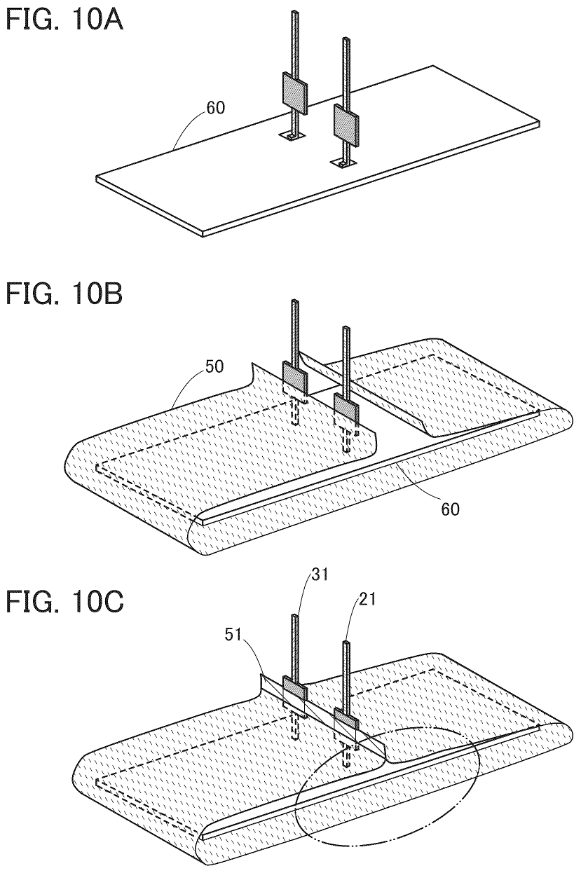

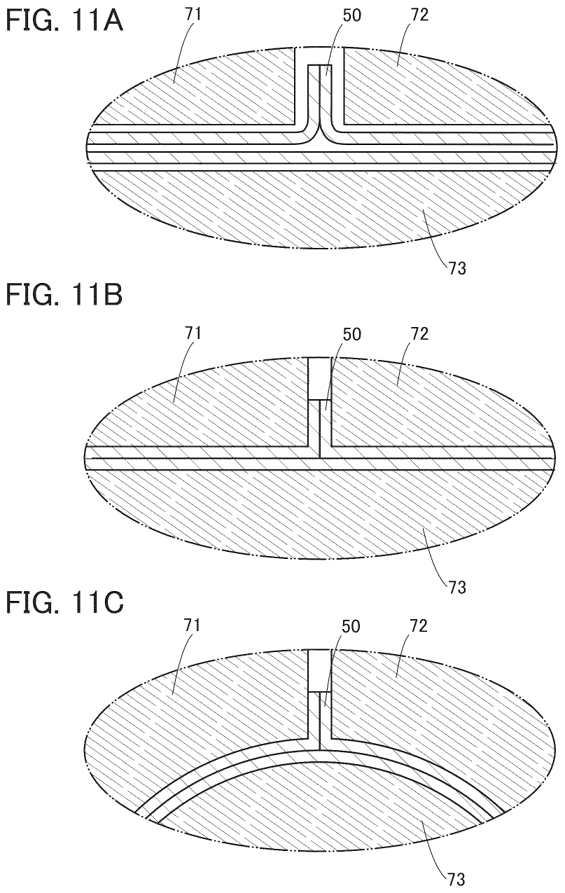

Then, the other end surface of the exterior body 50 is sealed (bonded) so as to surround the stacked body 60. A method for sealing (bonding) a portion indicated by a dashed double-dotted line in FIG. 10C is described with reference to FIG. 11A and FIG. 11B. After sealing of the portion indicated by the dashed double-dotted line in FIG. 10C, an electrolyte solution may be injected so that the stacked body 60 is filled with the electrolyte solution before the end surface opposite to the sealing portion is sealed in a similar manner. Alternatively, in sealing, the end surface opposite to the sealing portion may partly remain unsealed to serve as an injection port of the electrolyte solution. In that case, the injection port may be sealed after the electrolyte solution is injected from the injection port.

FIG. 11A and FIG. 11B are schematic side views illustrating a method for bonding the exterior body 50 to form a sealing portion in the portion indicated by the dashed double-dotted line in FIG. 10C. The exterior body 50 can be bonded by the aforementioned bonding method. In FIG. 11A and FIG. 11B, a method using a heat bar sealing apparatus is described.

As illustrated in FIG. 11A, the heat bar sealing apparatus includes a first heat bar 71, a second heat bar 72, and a third heat bar 73. The first heat bar 71, the second heat bar 72, and the third heat bar 73 are adjusted to a temperature that allows a resin layer included in the exterior body 50 to be fused. A portion of the exterior body 50 to be bonded is placed between the third heat bar 73 and each of the first heat bar 71 and the second heat bar 72. In that case, the sealing portion 51 illustrated in FIG. 10C is placed between the first heat bar 71 and the second heat bar 72.

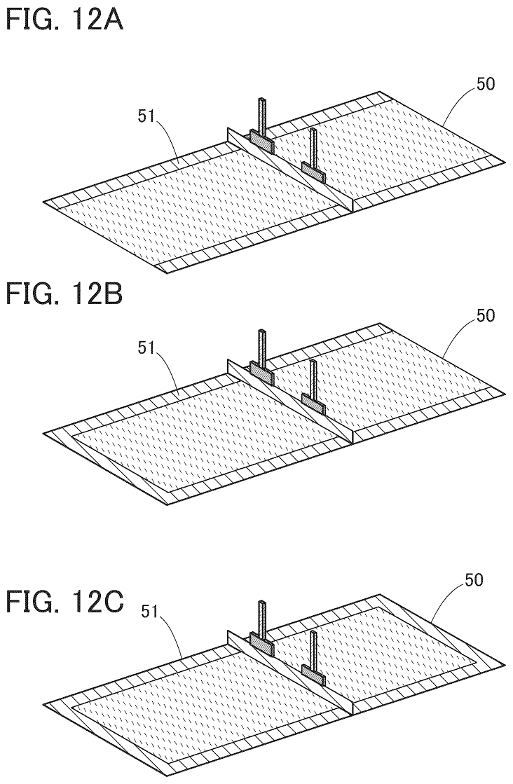

Then, as illustrated in FIG. 11B, the exterior body 50 is sandwiched by the first heat bar 71, the second heat bar 72, and the third heat bar 73 to be bonded. In that case, the first heat bar 71, the second heat bar 72, and the third heat bar 73 may operate so that the distance between the first heat bar 71 and the second heat bar 72, the distance between the first heat bar 71 and the third heat bar 73, and the distance between the second heat bar 72 and the third heat bar 73 are almost equal to one another. The secondary battery 10 illustrated in FIG. 1A, FIG. 12A, and the like can be manufactured in the aforementioned manner.

Note that in FIG. 11A and FIG. 11B, a method of bonding the exterior body 50 to have a linear shape is described; alternatively, the exterior body 50 may be bonded to have a curved shape as illustrated in FIG. 11C.

In the above, the secondary battery 10 including one exterior body 50 as illustrated in FIG. 1A, FIG. 12A, and the like and a manufacturing method thereof are described. However, the secondary battery 10 of one embodiment of the present invention is not limited thereto; the secondary battery 10 may include two exterior bodies 50 as illustrated in FIG. 12B or the secondary battery 10 may include three exterior bodies 50 as illustrated in FIG. 12C.

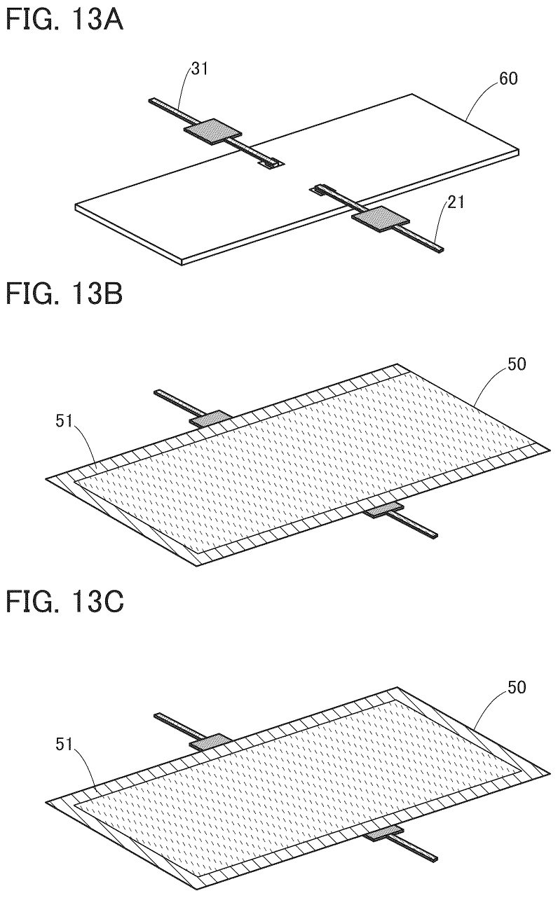

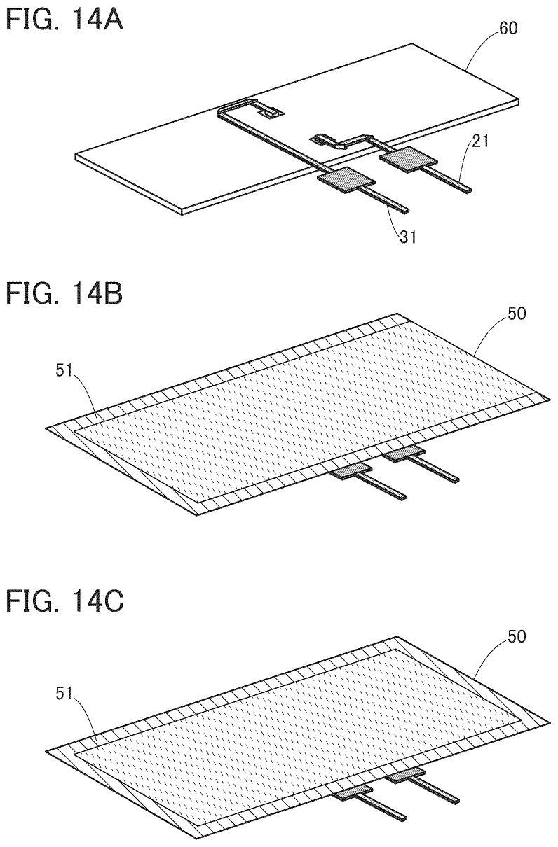

FIG. 1A, FIG. 12A, and the like illustrate an example in which the positive electrode lead 21 and the negative electrode lead 31 included in the stacked body 60 are provided to extend upward from surfaces in contact with the active material layers of the positive electrode 20 and the negative electrode 30. The stacked body 60 included in the secondary battery 10 of one embodiment of the present invention is not limited to the above structure and may have a structure in which the positive electrode lead 21 and the negative electrode lead 31 included in the stacked body 60 are provided to extend substantially parallel to the surfaces in contact with the active material layers of the positive electrode 20 and the negative electrode 30 as illustrated in FIG. 13A and FIG. 14A. In that case, the positive electrode lead 21 and the negative electrode lead 31 are preferably provided so as to be substantially perpendicular to the curved direction of the secondary battery 10 as illustrated in FIG. 13A and FIG. 14A. Such a structure can reduce the stress applied to the positive electrode lead connection portion or the negative electrode lead connection portion when the secondary battery 10 is curved. That is, it is possible to inhibit degradation of the positive electrode lead connection portion or the negative electrode lead connection portion.

FIG. 13A to FIG. 13C are diagrams illustrating an example in which the positive electrode lead 21 and the negative electrode lead 31 are provided to extend in different directions, and the positive electrode lead 21 and the negative electrode lead 31 are preferably provided to be positioned on the same straight line. FIG. 14A to FIG. 14C are diagrams illustrating an example in which the positive electrode lead 21 and the negative electrode lead 31 are provided to extend in the same direction.

FIG. 13B and FIG. 14B are schematic views illustrating the secondary battery 10 including one exterior body 50, and FIG. 13C and FIG. 14C are schematic views illustrating the secondary battery 10 including two exterior bodies 50.

Note that the positive electrode lead 21 and the negative electrode lead 31 illustrated in FIG. 12A to FIG. 14C may be provided so as to overlap with the midpoint or the vicinity of the midpoint in the curved direction of the secondary battery 10. That is, the positive electrode lead 21 and the negative electrode lead 31 may extend from the inside to the outside of the exterior body at the midpoint or in the vicinity of the midpoint in the curved direction of the secondary battery 10.

Next, films that can be used as the positive electrode 20, the negative electrode 30, an electrolyte, the separator 40, and the exterior body 50 are described. Note that the secondary battery 10 includes an electrolyte though the electrolyte is not described in the above description of the secondary battery 10 and in FIG. 1 to FIG. 14. It can also be said that a space surrounded by the exterior body 50 includes an electrolyte, the stacked body 60 includes an electrolyte, the positive electrode 20 includes an electrolyte, the negative electrode 30 includes an electrolyte, and the separator 40 includes an electrolyte, for example.

### [Negative Electrode]

A negative electrode includes a negative electrode active material layer and a negative electrode current collector. The negative electrode active material layer includes a negative electrode active material and may further contain a conductive material and a binder.

Metal foil can be used as the current collector, for example. The negative electrode can be formed by applying slurry onto the metal foil and drying. Note that pressing may be performed after drying. The negative electrode is obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### <Negative Electrode Active Material>

As the negative electrode active material, for example, a carbon material or an alloy-based material can be used.

As the carbon material, for example, graphite (natural graphite and artificial graphite), graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of a lithium metal.

Non-graphitizing carbon can be obtained by baking a synthetic resin such as a phenol resin, and an organic substance of plant origin, for example. In non-graphitizing carbon contained in the negative electrode active material of the lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind or a combination of various kinds of the negative electrode active materials described above can be used. For example, a combination of a carbon material and silicon or a combination of a carbon material and silicon monoxide can be used.

As another mode of the negative electrode, a negative electrode that does not contain a negative electrode active material after completion of the fabrication of the battery may be used. The negative electrode that does not contain a negative electrode active material can be, for example, a negative electrode in which only a negative electrode current collector is included after completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. As another film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case where the negative electrode that does not contain a negative electrode active material is used, a negative electrode current collector having projections and depressions can be used. In the case where the negative electrode current collector having projections and depressions is used, a depression of the negative electrode current collector becomes a cavity in which lithium contained in the negative electrode current collector is easily deposited, so that the lithium can be inhibited from having a dendrite-like shape when being deposited.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide or, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a “passivation film” refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of an active material surface, the case where a conductive material is embedded in projections and depressions of an active material surface, and the case where an active material and a conductive material are electrically connected to each other without being in contact with each other.

An active material layer such as the positive electrode active material layer or the negative electrode active material layer preferably contains a conductive material.

As the conductive material, for example, one kind or two or more kinds of carbon black such as acetylene black or furnace black, graphite such as artificial graphite or natural graphite, carbon fiber such as carbon nanofiber or carbon nanotube, and a graphene compound can be used.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably curved. The graphene compound may be rounded like a carbon nanofiber.

The active material layer may contain, as a conductive material, metal powder or metal fiber of copper, nickel, aluminum, silver, gold, or the like, a conductive ceramic material, or the like.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, a graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of a battery can be increased.

A particulate carbon-containing compound such as carbon black or graphite or a fibrous carbon-containing compound such as carbon nanotube easily enters a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the fabrication method of one embodiment of the present invention can have high capacity density and stability, and is effective as an in-vehicle battery.

### <Current Collector>

As the current collector, a highly conductive material which is not alloyed with a carrier ion such as lithium, for example, a metal such as stainless steel, gold, platinum, zinc, iron, copper, aluminum, or titanium, or an alloy thereof can be used. The current collector can have a sheet-like shape, a net-like shape, a punching-metal shape, an expanded-metal shape, or the like as appropriate.

A resin current collector can be used as the current collector. As the resin current collector, for example, a resin current collector including a resin such as polyolefin (e.g., polypropylene or polyethylene), nylon (polyamide), polyimide, vinylon, polyester, acrylic, or polyurethane, and a particulate or fibrous conductive material (also referred to as a conductive filler) can be used.

As the conductive material contained in the resin current collector, a conductive carbon material and one or more of metal materials such as aluminum, titanium, stainless steel, gold, platinum, zinc, iron, and copper can be used. For example, one kind or two or more kinds of carbon black such as acetylene black or furnace black, graphite such as artificial graphite or natural graphite, carbon fiber such as carbon nanofiber or carbon nanotube, graphene, and a graphene compound can be used as the conductive carbon material. Note that in the case where the resin current collector is used as a positive electrode current collector, an antioxidant such as a hindered phenol-based material is further preferably used.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanotube can be formed by, for example, a vapor deposition method.

Note that the average particle diameter of the conductive material contained in the resin current collector can be greater than or equal to 10 nm and less than or equal to 10 m, and is preferably greater than or equal to 30 nm and less than or equal to 5 m.

The current collector may have a thickness greater than or equal to 5 m and less than or equal to 30 m.

Note that a material that does not alloy with carrier ions of lithium or the like is preferably used for the negative electrode current collector.

### [Positive Electrode]

A positive electrode includes a positive electrode active material layer and a positive electrode current collector. The positive electrode active material layer includes a positive electrode active material and may further contain at least one of a conductive material and a binder. Note that the positive electrode current collector, the conductive material, and the binder described in [Negative electrode] can be used.

Metal foil can be used as the current collector, for example. The positive electrode can be formed by applying slurry onto the metal foil and drying. Note that pressing may be performed after drying. The positive electrode is obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

### <Positive Electrode Active Material>

As the positive electrode active material, one or more of a composite oxide having a layered rock-salt structure, a composite oxide having an olivine structure, and a composite oxide having a spinel structure can be used.

As the composite oxide having a layered rock-salt structure, one or more of lithium cobalt oxide, lithium nickel-cobalt-manganese oxide, lithium nickel-cobalt-aluminum oxide, and lithium nickel-manganese-aluminum oxide can be used. Note that the composition formula can be represented by LiM1O₂ (M1 is one or more selected from nickel, cobalt, manganese, and aluminum), and a coefficient of the composition formula is not limited to an integer.

As the lithium cobalt oxide, for example, lithium cobalt oxide to which magnesium and fluorine are added can be used. It is preferable to use lithium cobalt oxide to which magnesium, fluorine, aluminum, and nickel are added.

As the lithium nickel-cobalt-manganese oxide, for example, lithium nickel-cobalt-manganese oxide with a ratio such as nickel:cobalt:manganese=1:1:1, 6:2:2, 8:1:1, or 9:0.5:0.5 can be used. As the above-described lithium nickel-cobalt-manganese oxide, for example, lithium nickel-cobalt-manganese oxide to which one or more of aluminum, calcium, barium, strontium, and gallium are added is preferably used.

As the composite oxide having an olivine structure, one or more of lithium iron phosphate, lithium manganese phosphate, lithium cobalt phosphate, and lithium iron manganese phosphate can be used. Note that the composition formula can be represented by LiM2PO₄ (M2 is one or more selected from iron, manganese, and cobalt), and a coefficient of the composition formula is not limited to an integer.

Furthermore, composite oxide having a spinel structure, e.g., LiMn₂O₄, can be used.

### [Electrolyte]

An example of an electrolyte is described below. As one mode of the electrolyte, a liquid electrolyte (also referred to as an electrolyte solution) containing a solvent and an electrolyte dissolved in the solvent can be used. The electrolyte is not limited to a liquid electrolyte (an electrolyte solution) that is liquid at normal temperature, and a solid electrolyte can be used as well. Alternatively, an electrolyte including both a liquid electrolyte that is liquid at normal temperature and a liquid electrolyte that is a solid at normal temperature (such an electrolyte is referred to as a semi-solid electrolyte) can also be used. Note that when the solid electrolyte or the semi-solid electrolyte is used for a bendable battery, part of a stack in the battery includes the electrolyte, whereby the battery can maintain the flexibility.

In the case where a liquid electrolyte is used for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio, for example.

Alternatively, the use of one or more of ionic liquids (normal temperature molten salts) which have features of non-flammability and non-volatility as a solvent of an electrolyte can prevent a secondary battery from exploding or catching fire even when an internal region of a secondary battery shorts out or the temperature in the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, or the like can be used, for example.

For example, an organic solvent described in this embodiment contains ethylene carbonate (EC), ethyl methyl carbonate (EMC), and dimethyl carbonate (DMC). When the total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y:100−x−y (where 5×35 and 0<y<65) can be used. More specifically, an organic solvent containing EC, EMC, and DMC at EC:EMC:DMC=30:35:35 (volume ratio) can be used.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

When a high-molecular material that can gel is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

### [Separator]

When the electrolyte includes an electrolyte solution, a separator is placed between the positive electrode and the negative electrode. The separator can be formed using, for example, fiber containing cellulose, such as paper, nonwoven fabric, glass fiber, ceramics, or synthetic fiber containing nylon (polyamide), polyimide vinylon (polyvinyl alcohol-based fiber), polyester, acrylic, polyolefin, or polyurethane. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a polyimide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the battery can be improved. When the separator is coated with the fluorine-based material, the separator is easily brought into close contact with an electrode, resulting in high output characteristics. When the separator is coated with the polyamide-based material, in particular, aramid, heat resistance can be improved to improve the safety of the battery.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the battery can be increased because the safety of the battery can be maintained even when the total thickness of the separator is small.

### [Exterior Body]

For an exterior body included in the battery, a resin material or a metal material such as aluminum, stainless steel, or titanium can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a highly flexible (bendable) battery, for example, an aluminum laminated film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

A graphene sheet may be substituted for the above metal layer of the laminated film. As the graphene sheet, a multilayer graphene sheet with a thickness greater than or equal to 100 nm and less than or equal to 30 μm, preferably greater than or equal to 200 nm and less than or equal to 20 μm can be used. The graphene sheet is flexible and has a gas barrier property with the interlayer distance of graphene of 0.34 nm and thus is suitable as a film used for the exterior body of the secondary battery.

[Processing Method of Film with Projections and Depressions]

Next, a processing method of a film that can be used for the exterior body 50 will be described. The laminated film described above can be used as the film.

As the laminated film, for example, a stacked body, e.g., a metal film including a heat-seal layer on one surface or both surfaces, can be used. As an adhesive layer, a heat-seal resin film containing polypropylene, polyethylene, or the like can be used. In this embodiment, an aluminum laminated film in which a surface of aluminum foil is provided with a nylon resin and the rear surface of the aluminum foil is provided with a stack of an acid-proof polypropylene film and a polypropylene film is used.

Then, the film is embossed. As a result, the film having projections and depressions can be obtained. The film includes a plurality of projections and depressions, thereby having a wave pattern that can be visually recognized.

Embossing, which is a kind of pressing, will be described below.

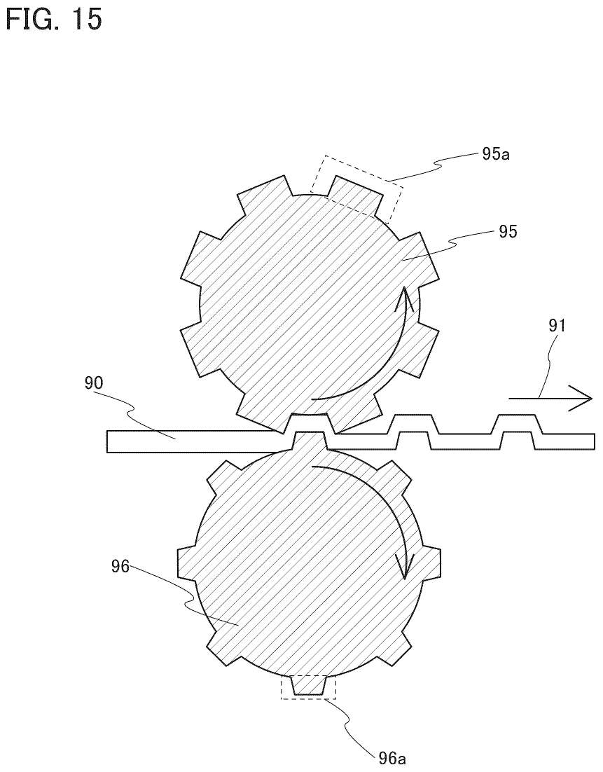

FIG. 15 is a cross-sectional view illustrating an example of embossing. Note that embossing, which is a kind of pressing, refers to processing for forming projections and depressions corresponding to projections and depressions of an embossing roll on a film by bringing the embossing roll whose surface has projections and depressions into contact with the film with pressure. Note that the embossing roll is a roll whose surface is patterned.

FIG. 15 illustrates an example in which both surfaces of a film are embossed. FIG. 15 illustrates a forming method of a film having projections whose top portions are on one surface side.

FIG. 15 illustrates the state where a film 90 is sandwiched between an embossing roll 95 in contact with one surface of the film and an embossing roll 96 in contact with the other surface and the film 90 is being transferred in a direction 91. The surface of the film is patterned by pressure or heat. The surface of the film may be patterned by pressure and heat.

As the embossing roll, a metal roll, a ceramic roll, a plastic roll, a rubber roll, an organic resin roll, a lumber roll, or the like can be used as appropriate.

In FIG. 15, embossing is performed using the male embossing roll 96 and the female embossing roll 95. The male embossing roll 96 has a plurality of projections 96a. The projections correspond to projections formed on a film to be processed. The female embossing roll 95 has a plurality of projections 95a. Between adjacent projections 95a, a depression is positioned into which a projection formed on the film by the projection 96a of the male embossing roll 96 fits.

Successive embossing by which the film 90 partly stands out and debossing by which the film 90 is partly indented can form a projection and a flat portion successively. In this manner, a pattern can be formed on the film 90.

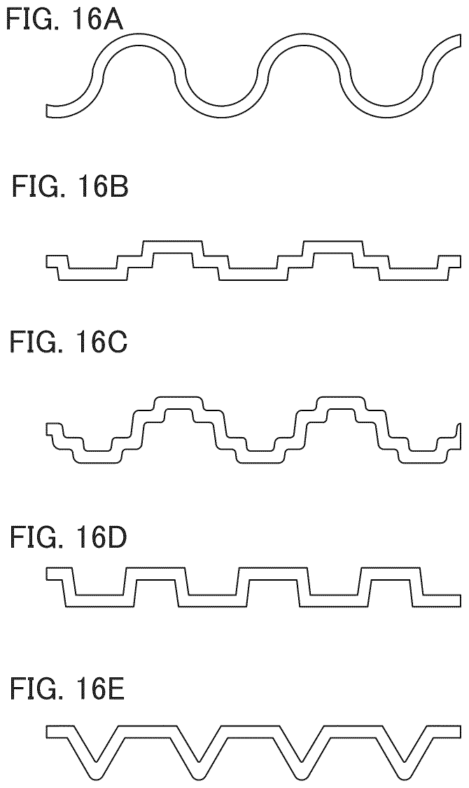

Next, a film having a plurality of projections with a shape different from that in FIG. 15 is described with reference to FIG. 16A to FIG. 16E. The shape of projections of the embossing roll 95 and the embossing roll 96 in FIG. 15 is changed to a shape different from that in FIG. 15, whereby embossing into various cross-sectional shapes illustrated in FIG. 16A to FIG. 16E can be performed.

FIG. 16A is a schematic cross-sectional view of an embossment having a wave shape, and FIG. 16B to FIG. 16E are modification examples of FIG. 16A. FIG. 16B and FIG. 16C are diagrams illustrating examples of forming a stepwise wave shape, FIG. 16D is a diagram illustrating an example of forming a rectangular wave shape, and FIG. 16E is a diagram illustrating an example of forming a wave shape with acute troughs and trapezoidal crests.

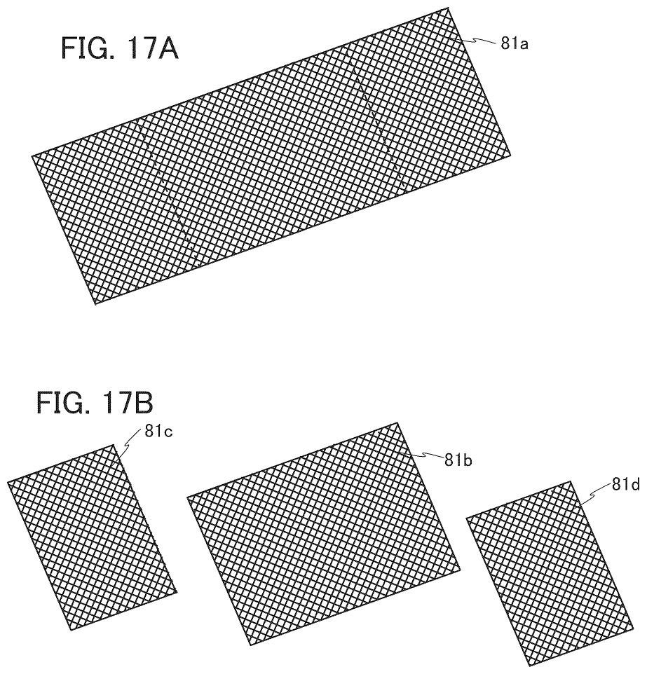

FIG. 17A and FIG. 17B are bird's eye views illustrating the completed shapes obtained by performing the embossing illustrated in FIG. 15 to FIG. 16E twice with different orientations of the film 90. Specifically, embossing is performed on the film 90 in a first direction, and then embossing is performed on the film 90 in a second direction that is rotated 90° with respect to the first direction, whereby a film 81 having an embossed shape (also referred to as an alternating wave shape) illustrated in FIG. 17A and FIG. 17B can be obtained. Note that when a secondary battery is fabricated using one film 81a, the film 81a having an alternating wave shape has an external shape illustrated in FIG. 17A and can be used by being folded in three along dashed line portions. When a secondary battery is fabricated using three films (a film 81b, a film 81c, and a film 81d), the plurality of films (the film 81b, the film 81c, and the film 81d) each having an alternating wave shape have an external shape illustrated in FIG. 17B, and the film 81b, the film 81c, and the film 81d can overlap with each other to be used.

When processing is performed using the embossing rolls in the aforementioned manner, an apparatus can be small. Furthermore, a film before being cut can be processed, achieving excellent mass productivity. Note that a film processing method is not limited to processing using embossing rolls; a film may be processed by pressing a pair of embossing plates having a surface with projections and depressions against the film. In that case, one of the embossing plates may be flat and the film may be processed in a plurality of steps.

In the above-described structure example of the secondary battery, the example is described in which the exterior body on one surface of the secondary battery and the exterior body on the other surface thereof have the same embossed shape; however, the structure of the secondary battery of one embodiment of the present invention is not limited thereto. For example, a secondary battery one surface of which is provided with an exterior body having an embossed shape and the other surface of which is provided with an exterior body not having an embossed shape can be used. Alternatively, the exterior body on one surface of the secondary battery and the exterior body on the other surface thereof may have different embossed shapes.

This embodiment can be implemented in appropriate combination with the other embodiments.

### Embodiment 2

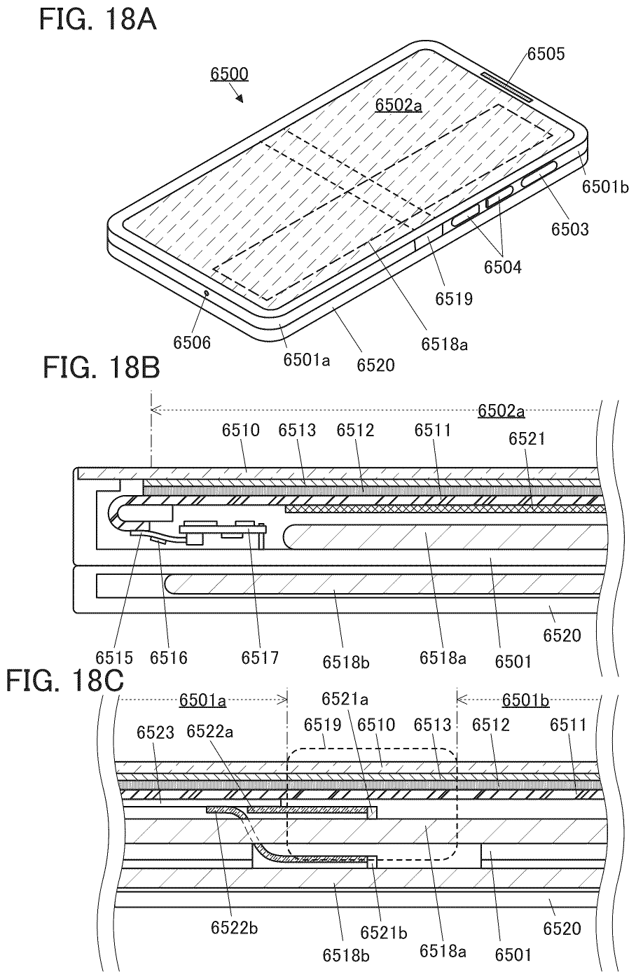

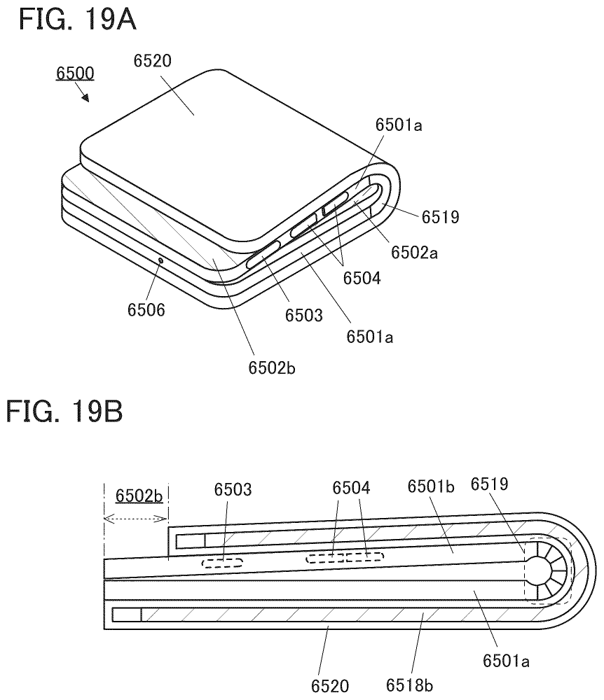

In this embodiment, an electronic device including the secondary battery 10 of one embodiment of the present invention will be described with reference to FIG. 18 and FIG. 19.

An electronic device 6500 illustrated in FIG. 18A is a portable information terminal that can be used as a smartphone.

The electronic device 6500 includes at least a first housing 6501a, a second housing 6501b, a hinge portion 6519, a display portion 6502a, a power button 6503, buttons 6504, a speaker 6505, and a microphone 6506. A display portion 6502 has a touch panel function. The first housing 6501a and the second housing 6501b are connected to each other through the hinge portion 6519.

The electronic device 6500 can be folded at the hinge portion 6519.

FIG. 18B is a schematic cross-sectional view including an end portion of a housing 6501 (6501a and 6501b) on the microphone 6506 side.

A protection member 6510 having a light-transmitting property is provided on the display surface side of the housing 6501 (6501a and 6501b), and a display panel 6511, an optical member 6512, a touch sensor panel 6513, a printed circuit board 6517, and a first battery 6518a are provided in a space surrounded by the housing 6501 (6501a and 6501b) and the protection member 6510.

The display panel 6511, the optical member 6512, and the touch sensor panel 6513 are fixed to the protection member 6510 with an adhesive layer (not illustrated).

Part of the display panel 6511 is folded back in a region outside the display portion 6502, and an FPC 6515 is connected to the part that is folded back. An IC 6516 is mounted on the FPC 6515. The FPC 6515 is connected to a terminal provided on the printed circuit board 6517.

A flexible display can be used as the display panel 6511. The flexible display includes a plurality of flexible films and employs a plurality of light-emitting elements arranged in a matrix. As the light-emitting elements, EL elements (also referred to as EL devices) such as OLEDs or QLEDs are preferably used. Examples of a light-emitting substance contained in the EL element include a substance that emits fluorescent light (a fluorescent material), a substance that emits phosphorescent light (a phosphorescent material), an inorganic compound (such as a quantum dot material), and a substance exhibiting thermally activated delayed fluorescence (a thermally activated delayed fluorescent (TADF) material). An LED such as a micro LED can also be used as the light-emitting element.

The use of the flexible display allows the display panel 6511 to be provided at a position overlapping with the first housing 6501a, the second housing 6501b, and the hinge portion 6519, and to be folded at the hinge portion 6519.

The use of the flexible display allows an internal space of the housing 6501 (6501a and 6501b) to be effectively utilized and an extremely lightweight electronic device to be achieved. Since the display panel 6511 is extremely thin, the first battery 6518a with high capacity can be mounted while the thickness of the electronic device is reduced.

Furthermore, in the electronic device 6500 using the high capacity battery, a second battery 6518b is provided inside a cover portion 6520 and is electrically connected to the first battery 6518a although the connection portion therebetween is not illustrated. The flexible battery of one embodiment of the present invention can be used as the first battery 6518a and the second battery 6518b.

The use of the flexible battery allows the battery to be provided at a position overlapping with the first housing 6501a, the second housing 6501b, and the hinge portion 6519, and to be folded at the hinge portion 6519.

FIG. 18C is a schematic cross-sectional view including the hinge portion 6519.

The first battery 6518a and the second battery 6518b each preferably include a battery connection portion 6521 (6521a and 6521b) provided with a positive electrode lead and a negative electrode lead in a region overlapping with the hinge portion 6519 or in the vicinity of the region overlapping with the hinge portion 6519. The battery connection portion 6521 can be electrically connected to a printed circuit board 6523 through an FPC 6522 (6522a and 6522b). The battery connection portion 6521 can include a protection circuit such as an overcharge protection circuit, an overdischarge protection circuit, an overcurrent protection circuit, or an overheating temperature protection circuit.

A battery 6518 extends from one side to the other side of the hinge portion 6519 and includes the battery connection portion 6521, and the battery connection portion 6521 is provided in the region overlapping with the hinge portion 6519 or in the vicinity of the region overlapping with the hinge portion 6519 as described above. Thus, as described in Embodiment 1, the battery 6518 can be curved with reduced stress applied to a positive electrode lead connection portion or a negative electrode lead connection portion included in the battery 6518. That is, degradation of the battery 6518 due to curving can be inhibited.

The first battery 6518a and the second battery 6518b each preferably include a portion fixed to the housing 6501 (6501a and 6501b) and a portion fixed to the cover portion 6520 in the region overlapping with the hinge portion 6519 or in the vicinity of the region overlapping with the hinge portion 6519. The first battery 6518a and the second battery 6518b can slide in the housing 6501 (6501a and 6501b) and the cover portion 6520 other than in the fixed portions, which facilitates curving of the battery 6518 inside the electronic device 6500.

Part of the display panel 6511 is folded back such that a connection portion with the FPC 6515 is provided on the rear side of the pixel portion, whereby an electronic device with a narrow bezel can be achieved.

When the flexible battery of one embodiment of the present invention is used as one or both of the first battery 6518a and the second battery 6518b, the electronic device 6500 can be partly folded to be downsized, so that the electronic device 6500 with high portability can be achieved.

FIG. 19A is a perspective view illustrating a folded state along the dotted line portion in FIG. 18A. The electronic device 6500 can be folded in half, the display portion 6502a and the second battery 6518b can be folded repeatedly.

FIG. 19A illustrates a structure in which a second display portion 6502b is provided in a portion exposed when the cover portion 6520 slides by folding. Even when the cover portion 6520 is folded in half, a user can check simple time display or e-mail reception notification display by seeing the second display portion 6502b.

FIG. 19B schematically illustrates a cross-sectional state of the cover portion in a state where the electronic device 6500 is folded. In FIG. 19B, the inside of the housing 6501 (6501a and 6501b) is not illustrated for simplicity.

In FIG. 19B, the hinge portion 6519 can be referred to as a connection portion and can have various modes as well as a structure example in which a plurality of columnar bodies are connected. It is particularly preferable that the hinge portion 6519 have a mechanism capable of curving the display portion 6502a and the second battery 6518b without stretching.

Although the second battery 6518b is illustrated inside the cover portion 6520, a plurality of second batteries may be included. In addition, a charging control circuit or a wireless charging circuit of the second battery 6518b may be provided inside the cover portion 6520.

In the example, the cover portion 6520 is partly fixed to the housing 6501 (6501a and 6501b) and is not fixed to a portion overlapping with the hinge portion 6519 and a portion overlapping with the second display portion 6502b that is exposed when the cover portion 6520 slides by folding.

The cover portion 6520 is not necessarily fixed to the housing 6501 (6501a and 6501b) and may be detachable. In the case where high capacity is not needed, the electronic device 6500 can be used while the cover portion 6520 is detached and the first battery 6518a is used. Charging of the detached second battery 6518b allows supplementary charging of the first battery 6518a when the second battery 6518b is reconnected to the first battery 6518a. Thus, the cover portion 6520 can also be used as a mobile battery.

FIG. 19A and FIG. 19B illustrate an example in which the display portion 6502a is folded in half such that the display surface faces inside; however, there is no particular limitation and the hinge portion 6519 may have a structure allowing the display portion 6502a to be folded in half such that the display surface faces outside.

The flexible battery of one embodiment of the present invention has high reliability with respect to repetitive deformation, and thus can be suitably used for the device that can be folded (also referred to as a foldable device).

At least part of this embodiment can be implemented in combination with the other embodiments described in this specification as appropriate.

### Embodiment 3

In this embodiment, examples of electronic devices each including the secondary battery 10 of one embodiment of the present invention as a flexible battery will be described. Examples of electronic devices each including a flexible battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines. Examples of the portable information terminals include laptop personal computers, tablet terminals, e-book readers, and mobile phones.

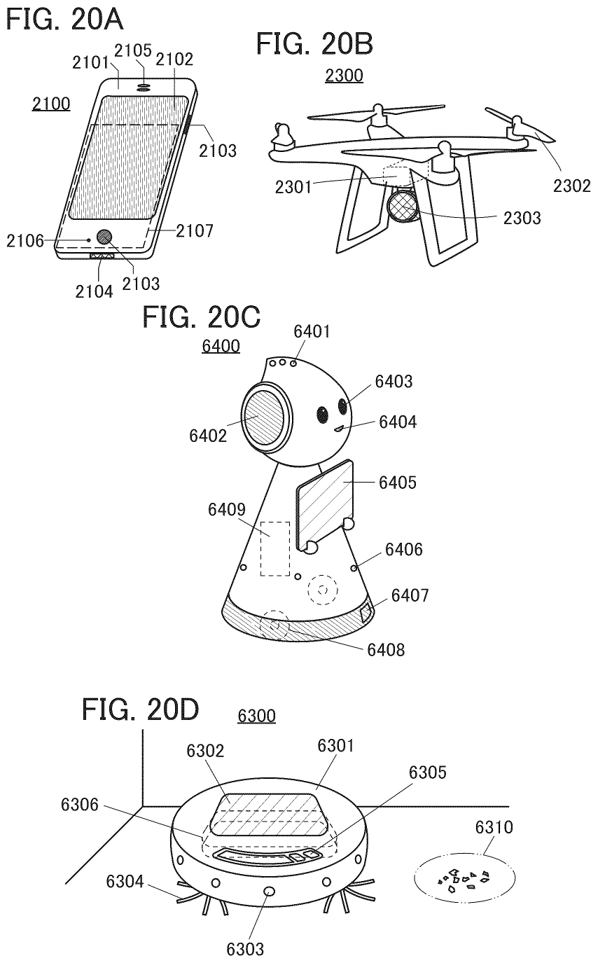

FIG. 20A shows an example of a mobile phone. A mobile phone 2100 is provided with a display portion 2102 incorporated in a housing 2101, operation buttons 2103, an external connection port 2104, a speaker 2105, a microphone 2106, and the like. Note that the mobile phone 2100 includes a flexible battery 2107. The flexible battery 2107 can be curved and thus can be mounted in a curved region of the mobile phone 2100.

The mobile phone 2100 is capable of executing a variety of applications such as mobile phone calls, e-mailing, viewing and editing texts, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 20B illustrates an unmanned aircraft 2300 including a plurality of rotors 2302. The unmanned aircraft 2300 is sometimes also referred to as a drone. The unmanned aircraft 2300 includes a flexible battery 2301 of one embodiment of the present invention, a camera 2303, and an antenna (not illustrated). The unmanned aircraft 2300 can be remotely controlled through the antenna. The flexible battery 2301 can be curved and thus can be mounted in a curved region of the unmanned aircraft 2300.

FIG. 20C illustrates an example of a robot. A robot 6400 illustrated in FIG. 20C includes a flexible battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like. The flexible battery 6409 can be curved and thus can be mounted in a curved region of the robot 6400.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the flexible battery 6409 of one embodiment of the present invention and a semiconductor device or an electronic component.

FIG. 20D illustrates an example of a cleaning robot. A cleaning robot 6300 includes a display portion 6302 placed on atop surface of a housing 6301, a plurality of cameras 6303 placed on a side surface of the housing 6301, a brush 6304, operation buttons 6305, a flexible battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface. The flexible battery 6306 can be curved and thus can be mounted in a curved region of the cleaning robot 6300.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the flexible battery 6306 of one embodiment of the present invention and a semiconductor device or an electronic component.

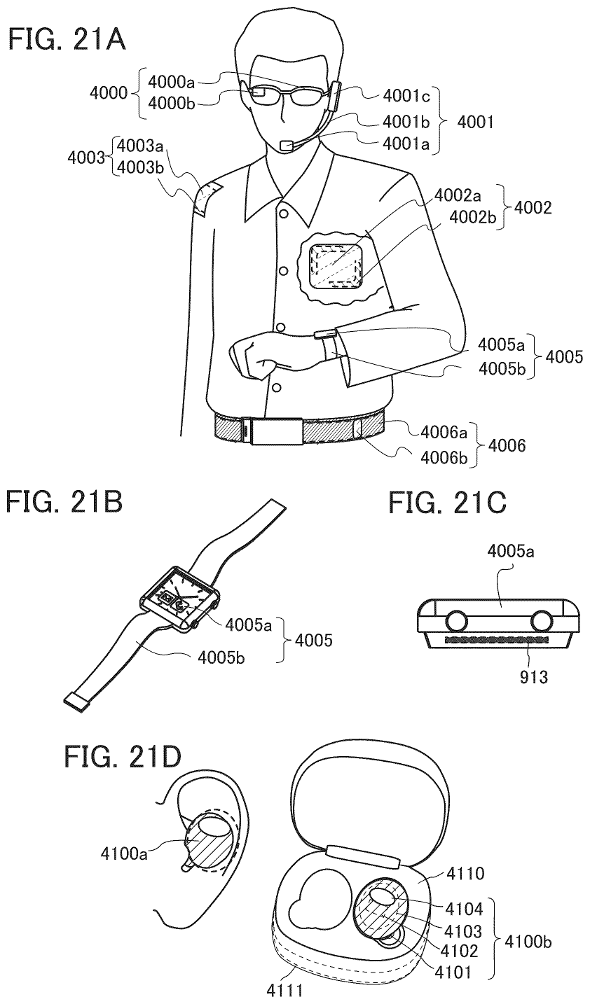

FIG. 21A illustrates examples of wearable devices. A flexible battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the flexible battery of one embodiment of the present invention can be mounted in a glasses-type device 4000 illustrated in FIG. 21A. The glasses-type device 4000 includes a frame 4000a and a display portion 4000b. The flexible battery is provided in a temple portion of the frame 4000a having a curved shape, whereby the glasses-type device 4000 can be lightweight, can have a well-balanced weight, and can be used continuously for a long time. The flexible battery can be curved and mounted in a curved portion.

The flexible battery of one embodiment of the present invention can be mounted in a headset-type device 4001. The headset-type device 4001 includes at least a microphone portion 4001a, a flexible pipe 4001b, and an earphone portion 4001c. The flexible battery can be provided in the flexible pipe 4001b or the earphone portion 4001c. The flexible battery can be curved and mounted in a curved portion.

The flexible battery of one embodiment of the present invention can be mounted in a device 4002 that can be attached directly to a body. A flexible battery 4002b can be provided in a thin housing 4002a of the device 4002. The flexible battery can be curved and mounted in a curved portion.

The flexible battery of one embodiment of the present invention can be mounted in a device 4003 that can be attached to clothes. A flexible battery 4003b can be provided in a thin housing 4003a of the device 4003. The flexible battery can be curved and mounted in a curved portion.

The flexible battery of one embodiment of the present invention can be mounted in a belt-type device 4006. The belt-type device 4006 includes a belt portion 4006a and a wireless power feeding and receiving portion 4006b, and the flexible battery can be mounted in the inner region of the belt portion 4006a. The flexible battery can be curved and mounted in a curved portion.

The flexible battery of one embodiment of the present invention can be mounted in a watch-type device 4005. The watch-type device 4005 includes a display portion 4005a and a belt portion 4005b, and the flexible battery can be provided in the display portion 4005a or the belt portion 4005b. The flexible battery can be curved and mounted in a curved portion.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be mounted therein. Data on the exercise quantity and health of the user can be stored to be used for health maintenance.

FIG. 21B illustrates a perspective view of the watch-type device 4005 that is detached from an arm.

FIG. 21C illustrates a side view. FIG. 21C illustrates a state where a flexible battery 913 is incorporated in the inner region. The flexible battery 913 is provided at a position overlapping with the display portion 4005a, can have high density and high capacity, and is small and lightweight. The flexible battery 913 can be curved and mounted in a curved portion.

FIG. 21D illustrates an example of wireless earphones. The wireless earphones illustrated here include, but are not limited to, a pair of main bodies 4100a and 4100b.

The main bodies 4100a and 4100b each include a driver unit 4101, an antenna 4102, and a flexible battery 4103. A display portion 4104 may also be included. Moreover, a substrate where a circuit such as a wireless IC is provided, a terminal for charge, and the like are preferably included. Furthermore, a microphone may be included. The flexible battery 4103 can be curved and mounted in a curved portion.

A case 4110 includes a flexible battery 4111. Moreover, a substrate where a circuit such as a wireless IC or a charge control IC is provided, and a terminal for charge are preferably included. Furthermore, a display portion, a button, and the like may be included. The flexible battery 4111 can be curved and mounted in a curved portion.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The flexible battery 4103 included in the main body 4100a can be charged by the flexible battery 4111 included in the case 4110. The flexible battery 4111 and the flexible battery 4103 can be curved and mounted in a curved portion.

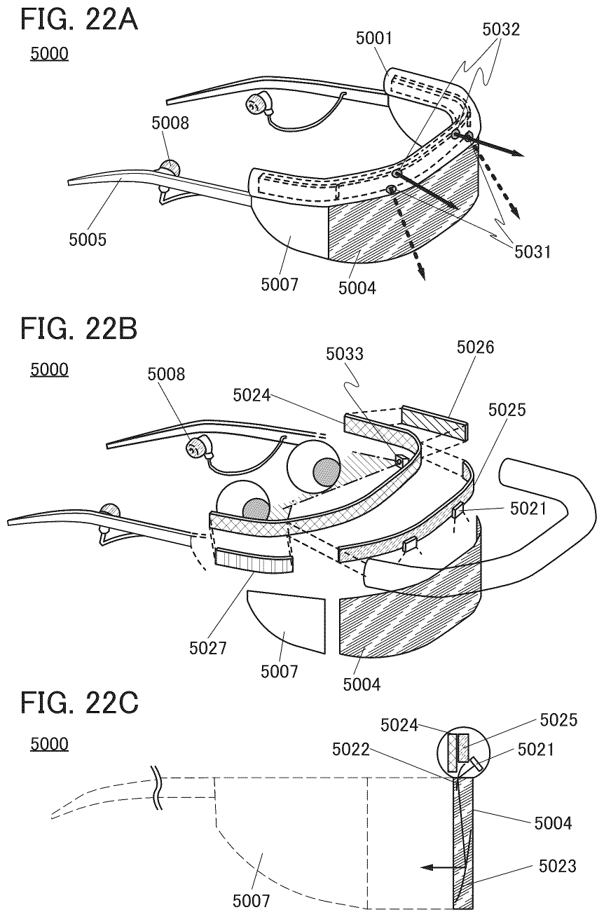

FIG. 22A to FIG. 22C illustrate another example of the glasses-type device. FIG. 22A is a perspective view of a glasses-type device 5000.

The glasses-type device 5000 has a function of what is called a portable information terminal and can execute a variety of programs and reproduce a variety of content when connected to the Internet, for example. For example, the glasses-type device 5000 has a function of displaying augmented reality content in the AR mode. The glasses-type device 5000 may have a function of displaying virtual reality content in the VR mode. Note that the glasses-type device 5000 may also have a function of displaying substitutional reality (SR) content or mixed reality (MR) content, in addition to AR and VR content.

The glasses-type device 5000 includes a housing 5001, an optical member 5004, a wearing tool 5005, a light-blocking unit 5007, and the like. The housing 5001 preferably has a cylindrical shape. The glasses-type device 5000 is preferably wearable on the user's head. Further preferably, the glasses-type device 5000 is worn such that the housing 5001 is positioned above the circumference of the user's head passing through eyebrows and ears. When the housing 5001 has a cylindrical shape that is curved along the user's head, the glasses-type device 5000 can fit more snugly. The housing 5001 is fixed to the optical member 5004. The optical member 5004 is fixed to the wearing tool 5005 with the light-blocking unit 5007 or the housing 5001 therebetween.

The glasses-type device 5000 includes a display device 5021, a reflective plate 5022, a flexible battery 5024, and a system unit. Each of the display device 5021, the reflective plate 5022, the flexible battery 5024, and the system unit is preferably provided inside the housing 5001. The system unit can be provided with a control unit, a memory unit, and a communication unit included in the glasses-type device 5000, a sensor, and the like. The system unit is preferably provided with a charging circuit, a power supply circuit, and the like. The flexible battery 5024 can be curved and mounted in a curved portion.

FIG. 22B illustrates components included in the glasses-type device 5000 in FIG. 22A. FIG. 22B and FIG. 22C are schematic views illustrating details of the components included in the glasses-type device 5000 illustrated in FIG. 22A.

In the glasses-type device 5000 illustrated in FIG. 22B and FIG. 22C, the flexible battery 5024, a system unit 5026, and a system unit 5027 are provided along the cylindrical housing 5001. A system unit 5025 is provided along the flexible battery 5024 and the like.

The housing 5001 preferably has a curved cylindrical shape. When the flexible battery 5024 is provided along the curved cylinder, the flexible battery 5024 can be provided efficiently in the housing 5001 and the space in the housing 5001 can be used efficiently; as a result, the volume of the flexible battery 5024 can be increased in some cases.

The housing 5001 has a cylindrical shape and the axis of the cylinder is along a part of a substantially elliptical shape, for example. A cross section of the cylinder is preferably substantially elliptical, for example. Alternatively, a part of a cross section of the cylinder preferably has a part of an elliptical shape, for example. In particular, in the case where the glasses-type device 5000 is worn on a head, the part of the cross section having a part of an elliptical shape is preferably positioned on a side facing the head. Note that one embodiment of the present invention is not limited thereto. For example, a part of a cross section of the cylinder may have a polygonal (e.g., triangular, quadrangular, or pentagonal) part.

The housing 5001 is formed so as to be curved along the user's forehead, for example. Alternatively, the housing 5001 is positioned along the user's forehead, for example.

The housing 5001 may be formed using two or more cases in combination. For example, the housing 5001 may be formed using an upper case and a lower case in combination. Alternatively, the housing 5001 may be formed using a case on an inner side (a side in contact with the user) and a case on an outer side in combination, for example. The housing 5001 may be formed using three or more cases in combination.

An electrode can be provided in a portion of the housing 5001 in contact with the user's forehead to measure brain waves using the electrode. Alternatively, an electrode may be provided in a portion in contact with the user's forehead to acquire information such as user's sweat using the electrode.

A plurality of flexible batteries 5024 may be provided inside the housing 5001.

The flexible battery 5024 can be provided along the curved cylinder, which is preferable. The flexible battery has flexibility, and thus can be positioned inside the housing more freely. The flexible battery 5024, a system unit, and the like are provided inside the cylindrical housing. The system unit is provided over a plurality of circuit boards, for example. The plurality of circuit boards and the flexible battery are connected using a connecter, a wiring, and the like. The flexible battery has flexibility, and thus can be positioned so as not to overlap with a connector, a wiring, and the like.

Note that the flexible battery 5024 may be provided, for example, inside the wearing tool 5005 as well as inside the housing 5001.

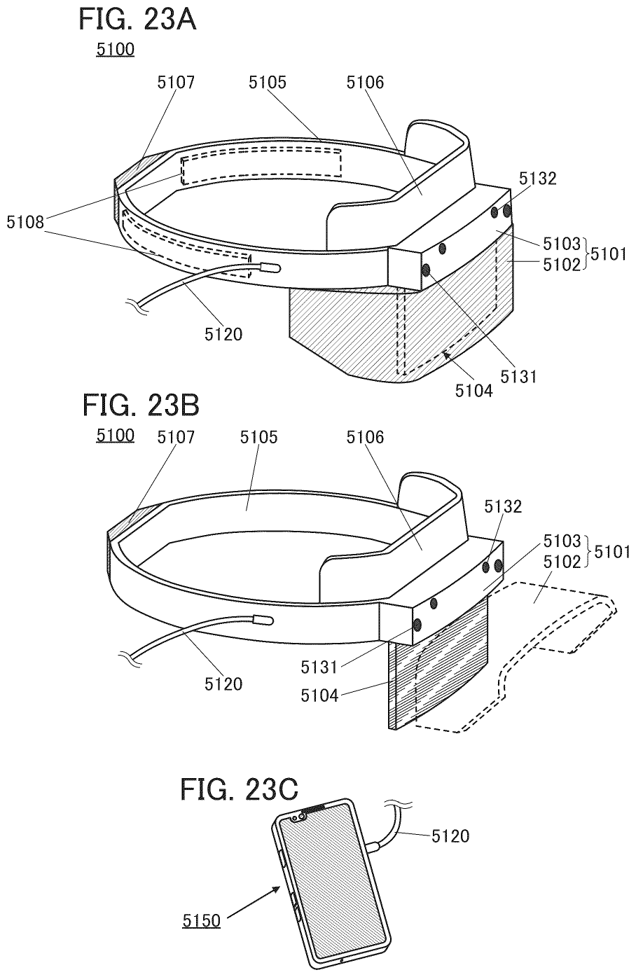

FIG. 23A to FIG. 23C illustrate an example of a head-mounted device. FIG. 23A and FIG. 23B illustrate a head-mounted device 5100 including a wearing tool 5105 with a band-like shape. The head-mounted device 5100 is connected to a terminal 5150 illustrated in FIG. 23C through a cable 5120.

FIG. 23A illustrates a first portion 5102 in a closed state, and FIG. 23B illustrates the first portion 5102 in an opened state. The first portion 5102 has a shape that covers not only the front but also the side of the face in the closed state. Accordingly, the user's view can be blocked from external light, so that realistic sensation and the sense of immersion can be increased. For example, it is also possible to increase user's sense of fear depending on content to be displayed.

In the electronic device illustrated in FIG. 23A and FIG. 23B, the wearing tool 5105 has a band-like shape. Accordingly, the electronic device is less likely to slip as compared with the structure illustrated in FIG. 23A and the like and thus is preferable in enjoying content with relatively large momentum, such as an attraction.

A flexible battery 5107 or the like may be incorporated on the rear head side of the wearing tool 5105. Finding a balance between the weight of the housing 5101 on the front head side and the weight of the flexible battery 5107 on the rear head side can adjust the center of gravity of the head-mounted device 5100, whereby the device can be worn more comfortably.

A flexible battery 5108 having flexibility may be provided inside the wearing tool 5105 with a band-like shape. FIG. 23A illustrates an example in which two flexible batteries 5108 are provided inside the wearing tool 5105. The flexible battery having flexibility is preferably used, in which case the flexible battery can have a curved band shape.

The wearing tool 5105 includes a portion 5106 covering the user's forehead or front head. Owing to the portion 5106, the wearing tool 5105 is less likely to slip. An electrode can be provided in the portion 5106 or a portion of the housing 5101 in contact with the user's forehead to measure brain waves using the electrode.

This embodiment can be implemented in appropriate combination with the other embodiments.

### REFERENCE NUMERALS

10: secondary battery, 20: positive electrode, 21: positive electrode lead, 22: positive electrode current collector, 23: positive electrode active material layer, 25: opening portion, 26: positive electrode current collector exposed portion, 30: negative electrode, 31: negative electrode lead, 32: negative electrode current collector, 33: negative electrode active material layer, 35: opening portion, 36: negative electrode current collector exposed portion, 40: separator, 45: opening portion, 47: bonding portion, 50: exterior body, 51: sealing portion, 60: stacked body, 81: film, 6500: electronic device, 6501a: first housing, 6501b: second housing, 6502: display portion, 6502a: display portion, 6502b: display portion, 6503: power button, 6504: button, 6505: speaker, 6506: microphone, 6510: protection member, 6511: display panel, 6512: optical member, 6513: touch sensor panel, 6515: FPC, 6516: IC, 6517: printed circuit board, 6518: battery, 6518a: first battery, 6518b: second battery, 6519: hinge portion, 6520: cover portion, 6521: battery connection portion, 6522: FPC, 6523: printed circuit board

1. A secondary battery comprising:
an external body surrounding a positive electrode, a negative electrode, and a separator; and
a positive electrode lead and a negative electrode lead which extend from the inside to the outside of the external body,
wherein the positive electrode comprises a positive electrode current collector exposed portion and a first opening portion,
wherein the negative electrode comprises a negative electrode current collector exposed portion and a second opening portion,
wherein the separator comprises a third opening portion and a fourth opening portion,
wherein the negative electrode lead is connected to the negative electrode current collector exposed portion at a position overlapping with the first opening portion and the third opening portion, and
wherein the positive electrode lead is connected to the positive electrode current collector exposed portion at a position overlapping with the second opening portion and the fourth opening portion.

2. The secondary battery according to claim 1, having flexibility,
wherein a first region is included in the vicinity of a midpoint in a curved direction of the secondary battery, and
wherein each of the first opening portion and the second opening portion comprises a region overlapping with the first region.

3. The secondary battery according to claim 2,
wherein the positive electrode lead and the negative electrode lead extend from the inside to the outside of the exterior body in the first region.

4. The secondary battery according to claim 1,
wherein the exterior body comprises a depression and a projection.

5. The secondary battery according to claim 4,
wherein the negative electrode is in contact with the exterior body with the separator therebetween.

6. An electronic device comprising the secondary battery according to claim 4.

7. An electronic device comprising:
a first housing;
a second housing;
a hinge portion; and
a flexible battery,
wherein the first housing is connected to the second housing through the hinge portion,
wherein the flexible battery is placed so as to overlap with the first housing, the second housing, and the hinge portion, and
wherein the flexible battery comprises a positive electrode lead and a negative electrode lead in a region overlapping with the hinge portion.

8. An electronic device comprising:
a first housing;
a second housing;
a hinge portion;
flexible battery; and
a flexible display,
wherein the first housing is connected to the second housing through the hinge portion,
wherein the flexible battery is placed so as to overlap with the first housing, the second housing, and the hinge portion,
wherein the flexible display is placed so as to overlap with the first housing, the second housing, and the hinge portion, and
wherein the flexible battery comprises a positive electrode lead and a negative electrode lead in a region overlapping with the hinge portion.
